(19) United States
(12) Patent Application Publication
(10) Pub. No.: US 2023/0109115 A1
(43) Pub. Date: Apr. 6, 2023

(54) WASH-DURABLE AND REUSABLE RESPIRATORY FACE MASK

(71) Applicant: Livinguard AG, Cham (CH)

(72) Inventors: Alexi TCHEREPANOV, Fairfax, CA (US); Markus HUTNAK, Santa Cruz, CA (US)

(21) Appl. No.: 17/493,388

(22) Filed: Oct. 4, 2021

(51) Int. Cl. A62B 23/02; A41D 13/11

(52) U.S. Cl. CPC A62B 23/025; A41D 13/11

(57) ABSTRACT

A wash-durable and reusable respiratory face mask for filtering air comprising a face part configured to cover at least the nose and the mouth of a head of a user includes two substantially symmetrical regions, where each region includes a top edge configured to form a trajectory which runs, when the mask is worn by the user, from the bridge of the nose of the head towards an ear of the head. The trajectory includes at least two sections, the first section being configured to cover at least part of the nose when the mask is worn by the user and forming a substantially convex bend, and the second section extending from the first section toward an ear.

### TECHNICAL FIELD

The present invention relates to a face mask, in particular a wash-durable and reusable respiratory face mask for filtering air, comprising a face part configured to cover at least the nose and the mouth of a head of a user and formed to suitably fit to the user's face to create a flush sealing and to prevent inhaling of unfiltered air. Advantageously, the mask is further soft, flexible and comfortable to wear, easy to transport and to store in a small space, because it can be folded easily without losing any beneficial properties inherent to the mask and provides for easy breathability for the user. The face mask can be used to protect the user and their environment, such as other persons, against airborne particulate and microbial pollution, and, in particular, to sanitize the inhaled air. Furthermore, the present invention is related to masks with filter efficiencies of at least N95/R95/P95 according to the NIOSH standard.

### BACKGROUND

Respiratory face masks are used in a wide range of life situations. Non-exhaustive examples of these include human beings wearing respiratory face masks to support them during work. This is especially important to prevent a substantial amount of airborne particulate matter, such as microbes, fine particles, and dust from entering the human body through the mouth or nose. Thereby, respiratory face masks are a valuable and mandatory requisite to minimize health risks, for instance lung diseases such as Chronic Obstructive Pulmonary Disease or Lung Cancer.

The field of applications of respiratory face masks comprise the industrial sector, such as construction sites, oil, gas or chemical manufacturing plants and laboratories but also the health sector, such as hospitals or medical offices, where high disinfection standards prevail because people there are exposed to infectious contaminations therein. Furthermore, the private sector is of growing importance for respiratory face masks, for instance human beings who seek to protect themselves and their fellow human beings in highly polluted areas or in the general environment. Recently, respiratory face masks, including ones with a high level of filtration of airborne particles, such as the N95/R95/P95 rated ones, have become a factor in the global community for limiting the spread of small droplets and aerosols containing viruses to restrict the Coronavirus disease 2019 (SARS-CoV-2, potentially causing the disease COVID-19).

COVID-19 has prompted a surge of demand in respiratory masks for limiting viral contagion across businesses and government organizations, and in particular across the broader population. Wearing of face masks has been encouraged or mandated, and the high demand of masks is preferably addressed by reusability of the mask, for economic and environmental reasons. When being washed and reused, the mask should maintain high filter efficiencies. The shape of the mask should be such as to ensure a tight and flush sealing to prevent air leakage and thus to increase the protection. Furthermore, the mask should have a comfortable fit, with little impairment in everyday situations, and be soft, flexible and light in weight. Ideally, the masks are cheap in production, and optionally have the ability to destroy microorganisms (termed “antimicrobial”) and non-living collection of molecules (termed “antiviral”) (both terms: “antimicrobial” and “antiviral” are captured here by the term “antimicrobial”). With such properties, acceptance in the public increases and spreading of diseases can effectively be contained.

Several attempts have been made in the prior art to bridge the gap and achieve the aforementioned challenging properties and requirements of the respiratory face mask.

Conventional FFP2, KN95 or N95 masks consist of non-woven filter material (e.g. meltblown-fleece). Therefore, these masks are not wash-durable and are typically not reusable. The masks generally do not have self-sanitizing or self-disinfecting properties. A potential manual disinfection and cleaning of the filter would adversely affect the filtration efficiency thereof. Furthermore, such masks have a high breathing resistance and lack a comfortable and soft fit.

The applicant has been distributing respiratory face masks labelled for instance Street Mask or Pro Mask, with antimicrobial and antiviral properties and suited for washing and reuse. Such a mask is referred to herein as the “prior art mask” and depicted in several drawings of the present application. The outer and inner layer of the mask is made of cotton fabric. The mask is substantially soft, flexible and light in weight. However, the prior art mask has a shape which may not create a tight sealing in particular around the nose and eye region when worn by a user. Furthermore, the front edge reveals substantial movement when a wearer in- and exhales so that the mask fabric is sucked close to the mouth or nose, potentially touching the mouth or nose when a wearer inhales, which increases breathing resistance, and the fabric becomes wet due to the close vicinity between material and mouth. This may irritate the user and compromises the acceptance of the user.

The elastic tapes of most of the above-mentioned masks are configured to be wrapped around the ears, thus they may cause local pain or hurt sensation or a feeling of irritation and discomfort when worn for a longer period of time.

### SUMMARY OF THE INVENTION

It is thus an object of the present invention to overcome some or all of the deficiencies of the prior art, in particular by providing a respiratory face mask whose shape is configured to create a tight sealing with the face of a user. In particular the face mask according to the invention should suit the head and face shape of a wide variety of persons, irrespective of their facial features typical for their origin, regional background and/or birthplace. Furthermore, the face mask should be comfortable to wear; in particular, it should be soft, flexible and light in weight, but it should at the same time maintain its shape in the portion in front of the mouth of the user when the user inhales and exhales. The mask should be reusable and wash-durable while maintaining high filtration efficiencies. The fixing mechanism of the mask should not lead to pain for the user and should hold the mask tight on the head of the user.

Some or all of the objects of the present invention are achieved by the subject matter of the independent claims. Preferred embodiments are subject of the dependent claims, and the skilled person finds hints for other suitable embodiments of the present invention through the overall disclosure of the present application. The solution relies in part in the special shape of the face mask. The mask is shaped in such a way that its edges go around or bypass some regions of the user's face. This concerns in particular regions of the user's face that are characterized by pronounced 3D surface variations. For that purpose, a special curvature of the edges of the mask is helpful.

A definitions section for this application included below may support the understanding of the invention.

A first embodiment of the invention is directed to a wash-durable and reusable respiratory face mask for filtering air comprising a face part configured to cover at least the nose and the mouth of a head of a user and comprising two substantially symmetrical regions and a front edge located at the border between the two regions and configured to form a trajectory (T1) which runs, when the mask is worn by the user, from the bridge of the nose of the head to the chin of the head, substantially at the symmetrical mirror plane (M1) of the face, wherein the front edge comprises a seam configured continuously along said trajectory (T1).

Generally, a continuous seam provides for more mechanical stability, integrity as well as tear resistance compared to configurations of seams that are not continuous.

According to a 2nd embodiment, in the first embodiment, the distance of any point on the trajectory (T1) from the symmetrical mirror plane (M1) of the face when the mask is worn by the user is at most 2.5 cm, preferably at most 2.0 cm, more preferably at most 1.5 cm and most preferably at most 1.0 cm.

With this arrangement, the trajectory T1, formed by the front edge of the mask lies substantially at the symmetrical mirror plane of the face, and thus the user benefits most from the location of the front seam and the front edge.

According to a 3rd embodiment, in any one of the preceding embodiments, the seam is a single stitch seam.

With this arrangement, manufacturing processes are simplified, and in particular mass production is supported.

A 4th embodiment of the invention is directed to a wash-durable and reusable respiratory face mask for filtering air, preferably according to any one of the preceding embodiments, comprising a face part configured to cover at least the nose and the mouth of a head of a user and comprising a preferably outer layer and two substantially symmetrical regions, wherein the layer is divided into at least two pieces along the border of the regions, and the two pieces are separate from and connected to each other with a seam.

With this arrangement, the creation of a 3D shape of the mask is simplified, because the seam may act as a supporting means of the at least two pieces. Furthermore, the structural integrity of the mask is improved by the seam. This also supports maintaining a certain shape of the mask even in the event of environmental challenges, such as wind, or breathing, that act on the mask.

According to a 5th embodiment, in the preceding embodiment and any one of the 1st to 3rd embodiments, the seam connecting the at least two pieces of the layer is the seam configured continuously along the trajectory (T1) which runs, when the mask is worn by the user, from the bridge of the nose of the head to the chin of the head.

With this arrangement, the connection between the two pieces can be achieved in a manner which supports the stability in particular of the front edge of the mask.

According to a 6th embodiment, in any one of the 4th to 5th embodiments, the face part comprises a second, preferably inner layer divided into at least two pieces along the border of the regions, wherein the two pieces are separate from and connected to each other with a seam.

With this arrangement, the creation of a 3D shape of the mask is further simplified, because the seam may act as a supporting means of the at least two pieces. Furthermore, the structural integrity of the mask is improved by the seam.

According to a 7th embodiment, in any one of the 4th to 6th embodiments, a layer comprises a sealing element overlapping the border of the regions.

Since the layer comprises two pieces which are separate from and connected to each other with a seam, unfiltered air or liquids splashed onto the mask could enter through the border of the regions. Furthermore, if the seam is realized, e.g. by stitching, the seam may comprise holes through which particulates may pass. Although this is of lesser concern for multi-layer masks, which represent preferred embodiments of the present invention, the sealing element provides additional protection. This arrangement allows to seal at least part of the border of the regions and increases health protection for the user and persons in their environment because it prevents leakage of unfiltered air or liquids through the seam. Furthermore, the sealing element advantageously increases the structural integrity and preferably makes the mask rigid in the areas of the mask where rigidity and form stability are needed, in particular at the front edge, so that when the user is breathing, the mask is prevented from touching the mouth or nose.

According to an 8th embodiment, in the preceding embodiment, the sealing element is attached to a layer of the face part, preferably by gluing, wherein the layer is preferably the outer layer.

This arrangement allows that for a tight and secure sealing of the seam, with the need of additional stitches, which might again create further leaks. Also, the portion where the sealing element is attached stays flexible and soft, so folding and storing the mask in a pocket is facilitated.

According to a 9th embodiment, in any one of the 7th and 8th embodiments, the width of the sealing element is in the range of 0.4-4.0 cm, preferably 0.6-3.5 cm, more preferably 0.8-3.0 cm and most preferably 1.0-2.5 cm; the sealing element runs from a starting location on the trajectory (T1) to an ending location on the trajectory (T1) of the front edge to substantially cover the seam, wherein the starting/ending location on the trajectory (T1) has a distance in the range of at most 4.0 cm, preferably at most 3.0 cm, more preferably at most 2.0 cm, and most preferably at most 1.5 cm from the start point/end point of the trajectory (T1); and/or the thickness of the sealing element is in the range of 0.05-1.0 mm, preferably 0.08-0.6 mm, more preferably 0.1-0.4 mm and most preferably 0.12-0.2 mm.

This arrangement allows to seal for instance the whole seam at the border of the regions. The width and thickness of the sealing element are suitably adjusted to ensure that enough material is provided to create a tight seal and firm attachment, but to prevent unnecessary material residues. Depending on the material/parts used for the sealing element as described in the 10th embodiment below, the thickness may vary. For instance, if silicon is applied as a material, the thickness may be greater than 1.0 mm, in particular the thickness may be in the range of 0.05-2.0 mm or 0.08-1.5 mm.

According to a 10th embodiment, in any one of the 7th to 9th embodiments, the sealing element comprises or consists of one or more selected materials/parts from the group consisting of seam sealing tape, Silicon, liquid stripe and Polyurethan, preferably the sealing element is a seam sealing tape.

With this arrangement, flexible and durable material properties of the sealing element are established. Also, it is light in weight, and thus does not create a gravity force acting on the front edge of the mask, which needs to remain particularly stable. If the sealing element is provided by means of a seam sealing tape, this may entail a superior advantage in view of cost effectiveness and furthermore this may facilitate manufacturing process. However, also the application of a liquid stripe may simplify the manufacturing process.

According to an 11th embodiment, in any one of the 7th to 10th embodiments, the sealing element is configured to be substantially non-permeable for liquids, aerosols and/or air, and/or has a relatively lower permeability to liquids, aerosols and/or air than a layer of the face part, and/or substantially seals the border of the regions.

This arrangement ensures that no dirt, water, and/or other elements will leak through the seam.

According to a 12th embodiment, in any one of the 6th to 11th embodiments, the face part comprises a third layer of a single-piece non-woven fabric that extends in both regions.

The non-woven fabric provides for efficient filtering, and the single-piece construction ensures that the full filter efficiency is provided across the entire face part.

According to a 13th embodiment, in the preceding embodiment, the first and second layers sandwich the third layer.

With this arrangement, the non-woven material, which may be a particulate filter material, is protected by an outer and inner layer. Among other impacts, the non-woven material is thus protected from mechanical forces, so that the mask can be washed for instance. This is because the rather fragile non-woven material would disintegrate if it was not protected from mechanical forces by the material surrounding it, e.g. a woven, knitted, warp-knitted, weft-knitted or crocheted textile material.

A 14th embodiment of the invention is directed to a wash-durable and reusable respiratory face mask for filtering air, preferably according to any one of the preceding embodiments, comprising a face part configured to cover at least the nose and the mouth of a head of a user and comprising two substantially symmetrical regions and a front edge located at the border between the two regions and configured to form a trajectory (T1) which runs, when the mask is worn by the user, from the bridge of the nose of the head to the chin of the head, substantially at the symmetrical mirror plane (M1) of the face, wherein the trajectory comprises at least two sections, each of which forms a substantially straight line, the first section being configured to cover at least part of the nose when the mask is worn by the user and the second section extending from the first section towards the mouth, and the acute angle (A1201) between the substantially straight lines formed by the first and second sections is in the range of 10-30°, preferably 15-25°, more preferably 17-23° and most preferably 18-22°.

This arrangement ensures that the material of the face mask may cover the bridge of the nose. This region of the human face, especially the vicinity of the bridge of the nose towards both eyes is characterized by lesser or fewer 3D shape variations than the region closer to the tip of the nose, e.g. at the dorsum nasi. Thus, sealing of the mask is improved if the top edge of the mask is formed along this region. Flat regions are typically easier to seal than a highly 3D variable surfaces or surfaces that are subject to strong 3D shape changes. Furthermore, the region of the bridge of the nose, which is substantially at the root of the nose, varies less from person to person within the population, irrespective of the person's regional or ethnic origin, than for instance the regions closer to the tip of the nose. The shape of the front edge follows smoothly the shape of the user's nose with little impairment for the user while a flush sealing is established.

According to a 15th embodiment, in the preceding embodiment, the trajectory (T1) comprises a third section forming a substantially straight line and extending from the second section towards the chin, and the acute angle (A1202) between the substantially straight lines formed by the second and third sections is in the range of 12-32°, preferably 15-29°, more preferably 18-26° and most preferably 20-24°.

This arrangement of substantially straight lines of the front edge has the advantage that fabric remnants or the waste of textiles can be reduced during the manufacturing process. That is because it enables the determination of more dense packages when the components of the mask are produced from the raw material, e.g. from textile material. Furthermore, this arrangement supports and facilitates the breathability of the mask, because an almost constant distance towards the mouth of the user can be ensured. The straight line of the third section is located sufficiently far away from the mouth of the user and it is furthermore mechanically supported by its connection to the second section, which assists in maintaining the shape while the mask is used.

According to a 16th embodiment, in the preceding embodiment, the length of the third section is in the range of 0.5-3.5 cm, preferably 1.0-3.0 cm, more preferably 1.5-2.5 cm and most preferably 1.8-2.2 cm.

The above arrangement ensures that the user's mouth is well covered by the mask and provides for a distance between the mask and the mouth to maintain a cup-shape of the mask in front of the mouth, which reduces impairment of the speaking process. This is achieved by the combination of the angles of the first, second and third sections. The length of the third section 123 is suitably selected so that it extends for a sufficiently large length in an arrangement preferably about parallel to the mouth. If it was too short it would not cover the mouth of the user with a suitable distance.

According to a 17th embodiment, in any one of the 15th to 16th embodiments, the trajectory (T1) comprises a fourth section extending from the third section to the chin, and the acute angle (A1203) between the substantially straight line of the third section and the tangent (K1201) of the fourth section at the start of the fourth section is in the range of 10-50°, preferably 20-40°, more preferably 25-35° and most preferably 27-33°.

In this arrangement, the fourth section 124 covers the lower region of the face, especially the chin portion of the user. The selection of the angle A1203 is such that the front edge starts a smooth transition towards the chin portion of the user and helps to maintain a certain distance to the mouth of the user.

According to an 18th embodiment, in the preceding embodiment, the acute angle (A1204) between the substantially straight line of the third section and the tangent (K1202) of the fourth section at the end of the fourth section is in the range of 35-90°, preferably 45-85°, more preferably 55-75° and most preferably 62-68°.

The advantage of this arrangement is that the tangent at the end of the fourth section 124 of the trajectory T1 formed by the front edge 120 matches the curvature of the chin of the user.

According to a 19th embodiment, in any one of the 17th to 18th embodiments, the fourth section forms a continuous bend such that L6b is in the range of 2.0-12.0%, preferably 4.0-10.0%, more preferably 5.5-8.5%, even more preferably 6.0-8.0% and most preferably 6.5-7.5% of L5b; wherein L5b is the length of a straight line between the start and the end of the fourth section when the mask lies flat and is folded at its mirror plane, and L6b is the greatest value of a perpendicular distance between a point on the fourth section and L5b.

This arrangement ensures that in the region around the chin of the user, where the length of the distance L6b plays a dominant role, is not unnecessarily large in relation to L5b as compared to masks of the prior art. Thereby, the manufacturing process is improved because cutouts from raw material can be packaged in a denser manner, which leads to less waste of material and/or textile. Furthermore, the distance of the mask material to the skin of the chin of the user can be reduced. The inventors found that this supports a better overall fit of the mask, in particular because these regions of the face are less susceptible to interference, hence it allows a closer fit of the mask to the user's face without irritating the user during speaking, breathing or doing any other activity. Moreover, this arrangement of the mask better follows the shape of all human beings irrespective of their facial features.

According to a 20th embodiment, in the preceding embodiment, the bend is substantially convex.

The convex bend of the fourth section ensures a smooth alignment of the mask or the face part with the chin of a user. The tangent at the end of the fourth section of the trajectory T1 formed by the front edge matches the curvature of the chin of the user.

According to a 21st embodiment, in any one of one of the 14th to 20th embodiments, the front edge has maximum angle deviations of 40°, preferably 350, most preferably 320 on a pathlength of the trajectory in the range of 0.1-4.0 cm, preferably 0.2-3.0 cm, more preferably 0.3-2.0 cm, even more preferably 0.4-1.0 cm and most preferably 0.5-0.8 cm; and/or the front edge has minimum angle deviations of 20°, preferably 25°, most preferably 28° on a pathlength of the trajectory in the range of 0.1-4.0 cm, preferably 0.2-3.0 cm, more preferably 0.3-2.0 cm, even more preferably 0.4-1.0 cm and most preferably 0.5-0.8 cm.

In such an arrangement the front edge better follows the natural shape of a user's head. In particular, the inventors found that this angle range matches the average front shape of a human's head. Thus, it ensures that the distance of the mask to the skin of the user's face is kept in beneficial ranges along the path of the trajectory T1 as opposed to different angle deviations. Furthermore, the visual acceptance and attraction to the face mask is improved as opposed to masks that reveal sharp angle variations and thus sharp corners in the front edge.

A 22nd embodiment of the invention is directed to a wash-durable and reusable respiratory face mask for filtering air, preferably according to any one of the preceding embodiments, comprising a face part configured to cover at least the nose and the mouth of a head of a user and comprising two substantially symmetrical regions and a front edge located at the border between the two regions and configured to form a trajectory (T1) which runs, when the mask is worn by the user, from the bridge of the nose of the head to the chin of the head, substantially at the symmetrical mirror plane (M1) of the face, the trajectory (T1) comprising at least one mouth section, which is located in the area in front of the mouth when the mask is worn by the user, wherein L1 is in the range of 2-6.5 cm, preferably 2.5-6 cm, more preferably 3-5.5 cm, even more preferably 3.5-5 cm and most preferably 4.0-4.8 cm; L1 is in the range of 5-60%, preferably 10-50%, more preferably 20-40%, even more preferably 25-35% and most preferably 26-32% of L2a; L3 is in the range of 2.5-7 cm, preferably 3-6.5 cm, more preferably 3.5-6 cm, even more preferably 4.2-5.6 cm and most preferably 4.6-5.2 cm; and/or L3 is in the range of 20-45%, preferably 25-40%, more preferably 28-36%, even more preferably 30-34% and most preferably 31-33% of L2b; wherein L1 is the smallest distance between the mouth section and the foremost contact point of the lips of the closed mouth when the mask is worn by the user, L2a is the length of a straight line between the start and the end of the trajectory (T1), L2b is the length of a straight line between the start and the end of the front edge when the mask lies flat and is folded at its mirror plane, and L3 is the greatest value of a perpendicular distance between a point on the trajectory (T1) of the front edge and L2b.

In this arrangement, although the mask is soft and flexible, the face part is prevented from getting in touch with the mouth when the user inhales, or at least the likelihood of this to happen is reduced, by virtue of the increased distance between the front edge and the mouth. This keeps the mask dry and is less of an impediment when speaking. Consequently, this leads to less irritation for the user. It also allows for the user to cough or the like, while a reliable sealing of the face is maintained. This is because the spacious room which is built up between the user's mouth and the front edge 120 enables the coughed air to flow in a more distributed manner in all directions within the mask and not locally in one direction.

According to a 23rd embodiment, in the preceding embodiment, the mouth section is substantially disposed at a point of the trajectory (T1) where the distance to the foremost contact point of the lips of the closed mouth is smallest.

This arrangement allows for maintaining the distance of the mask material to the mouth of the user.

A 24th embodiment of the invention is directed to a wash-durable and reusable respiratory face mask for filtering air, preferably according to any one of the preceding embodiments, comprising a face part configured to cover at least the nose and the mouth of a head of a user and comprising two substantially symmetrical regions, each region comprising a top edge configured to form a trajectory (T2) which runs, when the mask is worn by the user, from the bridge of the nose of the head towards an ear of the head, wherein the trajectory (T2) comprises at least two sections, the first section being configured to cover at least part of the nose when the mask is worn by the user and forming a substantially convex bend, and the second section extending from the first section towards an ear.

With this arrangement a tight and smooth fit of the mask as well as an improved sealing is established. The starting location of the top edge at the bridge of the nose ensures that along the direction of the trajectory T2, the top edge is exposed to only small 3D surface variations of the user's face as opposed to a starting location of the top edge at a region closer to the tip of the nose, e.g. at the dorsum nasi. This simplifies and supports sealing of the mask. In the prior art mask, it is hard to create a tight sealing, for instance in the area between the eye pockets and the cheek bones and in the area between the eye pockets and the nose. The inventors found that the convex bend particularly ensures a better sealing in these areas. The convex bend has the further benefit that the top edge goes downwards to a lower vertical height (for “vertical height”, see definition below) along the path of the trajectory T2 compared to the prior art mask. Thereby, it improves the vision of the user. That is because unlike the prior art mask, the view area of the user is not interfered by the mask, because it sits closer to the skin and is at some regions located on a lower vertical height. The prior art mask on the other hand may be lifted off the skin in the area between the eye pockets and the nose. Thereby, the vision of the user may be adversely affected due to a potential interference of the mask with the view area.

According to a 25th embodiment, in the preceding embodiment, the second section forms a substantially concave bend.

This arrangement allows for maintaining a smooth fit and flush seal of the top edge in the area between the eye pocket and the cheek bone, because the top edge runs in a region of the face which has a flatter or more even surface. This flatter surface region may be near or in close proximity to the cheekbone. If the second section had not such a concave bend, like in the prior art mask, it would pass a region of the face which is more dominated by 3D shape variations of the surface and a region which is more susceptible to variations between human beings, also humans of the same ethnic, origin and/or regional background. That is because the upper region of a human's face varies less then lower regions.

According to a 26th embodiment, in any one of one of the 24th to 25th embodiments, the acute angle (A1401) between the tangent (K1401) of the first section at the start of the first section and the tangent (K1403) of the second section at the end of the second section is in the range of 20-60°, preferably 30-50°, more preferably 35-45° and most preferably 37-43°.

With this arrangement, the fit of the top edge to the user's face is improved because the angle A1401 is large enough so that the top edge runs substantially towards the eyes before it runs to a lower vertical height (for “vertical height”, see definition below) along the side of the nose. Thus, the region of the face having large 3D surface shape variations is avoided. In comparison, the prior art masks have a smaller angle and consequently the top edge immediately runs to a lower vertical height (for “vertical height”, see definition below) along the side of the nose. Therefore, securing the seal is an immanent issue for the prior art masks.

According to a 27th embodiment, in any one of one of the 24th to 26th embodiments, the maximum value of the acute angle (A1402) between the tangent (K1403) of the second section at the end of the second section and the tangent (K140m) of the first section at any point of the first section is in the range of 50-90°, preferably 60-80°, more preferably 65-75° and most preferably 68-72°.

A common issue of prior art masks is that the glasses are positioned close to the edge of the mask on the skin of the user's face or on the edge of the mask. Sometimes the glasses are positioned even further outside the scope of the mask on the nose. If the glasses sit on the edge of the mask, it creates an uncomfortable feeling for the user since the glasses are lifted up in an unnatural way, because the edges of prior art masks are typically thick. Thus, the glasses are not positioned in their natural way. Also, using these prior art masks the glasses get fogged up easily, because air can leak especially through the top edge in the region at the side of the nose where a proper seal cannot be provided and thus vision for glass wearers is impaired. In the arrangement of the 27th embodiment, a beneficial solution is established of a good vision for the user and the top edge going around or bypassing regions of the user's face characterized by high 3D surface shape variations. It provides the additional benefit for glass wearers that the glasses may be positioned completely in a region of the face which is fully covered by the mask or the face part of the mask, with the top edge of the mask expanding further to the region behind the glasses. That is also achieved by the higher starting location of the mask on the bridge of the nose. Furthermore, when the glasses are positioned on top of the mask, they exercise a force on the face part of the mask in the direction of the skin of the user, which additionally improves sealing.

According to a 28th embodiment, in any one of one of the 24th to 27th embodiments, the obtuse angle (A1403) between the tangent (K1402) of the second section at the start of the second section and the tangent (K1403) of the second section at the end of the second section is in the range of 110-180°, preferably 130-165°, more preferably 139-155° and most preferably 143-151°.

According to a 29th embodiment, in any one of one of the 24th to 28th embodiments, the point (P140m) in which the second section extends from the first section is located on the trajectory (T2) with the greatest perpendicular distance between the point (P140m) and a straight line connecting the start and the end of the trajectory (T2).

According to a 30th embodiment, in any one of one of the 24th to 29th embodiments, L1402 is in the range of 0.5-3.5 cm, preferably 1.0-3.0 cm, more preferably 1.5-2.5 cm, even more preferably 1.8-2.2 cm and most preferably 1.9-2.1 cm; and/or L1402 is in the range of 5-40%, preferably 10-35%, more preferably 14-30%, even more preferably 18-26% and most preferably 20-24% of L1401; wherein L1401 is the length of a straight line between the start and the end of the top edge when the mask lies flat and is folded at its mirror plane, and L1402 is the greatest value of a perpendicular distance between a point (P140m) on the trajectory (T2) of the top edge and L1401.

The arrangements of the 28th to the 30th embodiment specify the advantageous features of the top edge in more detail. The length of the straight line L1401 from a point of the top edge at the bridge of the nose to the point of the top edge at its end in the region of the cheek bones serves as a reference length. This reference length is used to relate another length L1402, which is described below, to it. Since the top edge has a curvature or is bent, there is a distance between a point of the top edge and a corresponding point on the straight line L1401 that serves as a reference length. This distance, which is the length L1402 has its greatest value at point P140m of the top edge, which may be located for instance somewhere in the middle of the path of the top edge. The specified length of L1402 ensures that a better sealing can be achieved. In particular, it guarantees that the contours of the region between the nose and the area below the eyes of the user's face are better modeled than by prior art masks. That is because this length is substantially greater in the present invention than in the prior art masks. Furthermore, it is ensured that only as much material as necessary is used to realize the sealing advantage over the prior art masks. Therefore, unnecessary surplus material is not accumulated during the manufacturing procedure.

According to a 31st embodiment, in any one of the 24th to 30th embodiments, the end of the trajectory T2 and/or the end of the top edge is located in a negative-Y-direction of a length L1403 of 0.2-3.0 cm, preferably 0.4-2.0 cm, more preferably 0.5-1.5 cm and most preferably 0.7-1.2 cm, with respect to the point in which the second section extends from the first section, wherein the negative-Y-direction is the direction from the start of a front edge to the end of a front edge of the face part (105) wherein the front edge is comprised by the face part (105) and located at the border between the two regions (110a, 110b) and configured to form a trajectory T1 which runs, when the mask is worn by the user, from the bridge of the nose of the head to the chin of the head, substantially at the symmetrical mirror plane (M1) of the face.

This arrangement allows for the top edge to follow the natural curvature of the cheekbones of a user towards the ears. If the end of the trajectory T2 were to stop at a substantially lower negative-Y-direction, e.g. more towards the upper region of the head, more material for the manufacturing would be required. In addition, the area in a lower negative-Y-direction, e.g. the region towards the beginning of the hair or at least on a vertically higher position, does not need to be covered by the face mask. That is because the inventors found that a flush sealing can already be achieved at the position as specified in the arrangement of the 31st embodiment. Furthermore, the specified location of the ending of the top edge and the tangent of the ending of the top edge of this arrangement support the fixing means to be attached to the face part. These fixing means fix the face part to the head of the user and run around the head on a vertical height above the ears (for “vertical height”, see definition below). If the ending of the top edge was at a substantially higher negative-Y-direction, that means the ending was at a substantially lower region of the face, the fixing means would need to expand across a greater length to reach the position above the ears. In this respect, “above the ears” is to be understood as on a vertical height (for “vertical height”, see definition below) slightly greater than the ears so that the fixing means can ensure a proper fixing. Furthermore, in this case, the fixing means would need to be longer and consequently they would be in touch with a longer region of the user's head and may lead to irritation for the user and may adversely affect the otherwise natural perception or tactile sense that a user's skin usually provides for. However, many other known fixing means and/or ending positions of the top edge may be applied consistent with the spirit of the invention.

A 32nd embodiment of the invention is directed to a wash-durable and reusable respiratory face mask for filtering air, preferably according to any one of the preceding embodiments, comprising a face part configured to cover at least the nose and the mouth of a head of a user and comprising two substantially symmetrical regions, each region comprising a bottom edge configured to form a trajectory (T3) which runs, when the mask is worn by the user, from a bottom part of a chin portion of the head towards a jawbone portion of the head, wherein the obtuse angle (A1501) between the tangent (K1501) of the trajectory (T3) at the start of the trajectory (T3) and the tangent (K1502) of the trajectory (T3) at the end of the trajectory (T3) is in the range of 90-140°, preferably 95-130°, more preferably 100-120° and most preferably 105-115°.

With this arrangement, the bottom edge follows the shape of the user's head very closely and avoids regions of the face which are characterized by large 3D shape variations, as opposed to prior art masks. Thus, the sealing is improved.

According to a 33rd embodiment, in the preceding embodiment, the angle variation of a tangent of the trajectory (T3) at a point of the trajectory (T3) and the tangent (K1501) of the trajectory (T3) at the start of the trajectory (T3) is greater in the first half of the trajectory (T3) than in the second half of the trajectory (T3).

According to a 34th embodiment, in any one of the 32nd to 33rd embodiments, the obtuse angle (A150m) between the tangent (K150m) of the trajectory (T3) at the midpoint of the trajectory (T3) and the tangent (K1501) of the trajectory (T3) at the start of the trajectory (T3) is in the range of 105-165°, preferably 120-152°, more preferably 130-142° and most preferably 134-138°.

The arrangements of the 33rd and the 34th embodiment allow for the bottom edge to reach a flat region of the user's face, in particular of the user's chin, which is in general easier to seal, already after less than half of the length of the trajectory T3. Therefore, the region between the chin and the lower jawbone is bridged in less than half of the length of the trajectory T3, and the remaining length of the bottom edge 150 along the trajectory T3 is advantageously used to better seal the mask on the flat jawbone portion of the face.

A 35th embodiment of the invention is directed to a wash-durable and reusable respiratory face mask for filtering air, preferably according to any one of the preceding embodiments, comprising a face part configured to cover at least the nose and the mouth of a head of a user and comprising two substantially symmetrical regions, each region comprising at least one edge comprising a binding tape which is longish and elastic, wherein the edge is obtainable by performing the following steps:
elongating the binding tape in the longitudinal direction by a surplus of 2-30%, preferably 4-20%, more preferably 6-16% and most preferably 8-12% of its original length;
attaching the elongated binding tape to the edge.

With this arrangement, a tight seal is ensured and at the same time a comfortable feeling for the user. This pre-stretching procedure of the binding tape furthermore ensures that when the mask is worn by a user, the number of folds and wrinkles of the face part material is reduced. The inventors found that the specification of the surplus elongation has the particular advantage that the fitting of the mask is not too loose. At the same time, it is also not too strong, which could be painful and is not necessary for the purpose of providing for a sufficient seal. In contrast, the prior art masks do not reflect these considerations and are either too strong or too loose.

According to a 36th embodiment, in the preceding embodiment, the edge which comprises the binding tape is a bottom edge configured to form a trajectory (T3) which runs, when the mask is worn by the user, from a bottom part of a chin portion of the head towards a jawbone portion of the head.

This arrangement provides for a flush sealing especially for the bottom edge. The bottom edge of the mask is typically subject to movements due to displacements or motions of the lower jaw of the user. Therefore, especially in the region of a bottom edge of a face mask, a tight seal is required to ensure that no unfiltered air is exhaled or inhaled by the user.

According to a 37th embodiment, in any one of the 35th to 36th embodiments, the binding tape comprises or consists of one or more materials selected from the group consisting of polyester, polyamide (nylon), acrylic polyester, elastane (spandex, lycra), preferably elastane and polyamide, wherein the amount of elastane is preferably in the range of 10-30%, more preferably 15-25% and most preferably 18-23%.

These materials have a high abrasion resistance and can withstand higher mechanical forces, triggered for instance by tearing. This is particularly advantageous for prolonged use of the reusable mask. Furthermore, polyamide fabric for instance is light in weight and reveals a good dyeability, especially when compared to polyester. Thus, the modification of the surface of the binding tape is facilitated. Furthermore, the outward appearance can easily be changed.

A 38th embodiment of the invention is directed to a wash-durable and reusable respiratory face mask for filtering air, preferably according to any one of the preceding embodiments, comprising a face part configured to cover at least the nose and the mouth of a head of a user, and comprising two substantially symmetrical regions, each region comprising a bottom edge configured to form a first trajectory (T3) which runs, when the mask is worn by the user, from a bottom part of a chin portion of the head towards a jawbone portion of the head, and each region (110a, 110b) further comprising a rear edge (160) facing an ear of the user, the rear edge (160) configured to form a second trajectory (T4) which runs, when the mask is worn by the user, from a jawbone portion of the head towards a cheekbone portion of the head, wherein the angle (A1601) facing the face part and formed between the tangent (K1502) of the first trajectory (T3) at the end of the first trajectory (T3) and the tangent (K1601) of the second trajectory (T4) at the start of the second trajectory (T4) is in the range of 80-140°, preferably 90-130°, more preferably 100-120° and most preferably 105-115°.

In this arrangement, the rear edge forms an angle which does not deviate much from that of a rectangle. This simplifies, for instance during manufacturing, the determination of cutouts of the materials that the mask comprises. Therefore, denser packaging can be produced when the components of the mask are made from the raw material, e.g. from textile material. In other words, the yield of the fabric is increased, and the waste is consequently decreased.

According to a 39th embodiment, in the preceding embodiment, each region further comprises a top edge configured to form a third trajectory (T2) which runs, when the mask is worn by the user, from the bridge of the nose of the head towards an ear of the head, wherein the angle (A1602) facing the face part and formed between the tangent (K1403) of the third trajectory (T2) at the end of the third trajectory (T2) and the tangent (K1602) of the second trajectory (T4) at the end of the second trajectory (T4) is in the range of 74-114°, preferably 84-104°, more preferably 88-100° and most preferably 92-96°.

According to a 40th embodiment, in any one of the 38th to 39th embodiments, the trajectory (T4) forms a continuous bend such that L8b is in the range of 1.0-12.0%, preferably 2.0-10.0%, more preferably 3.0-7.0% and most preferably 5.5-4.5% of L7b; wherein L7b is the length of a straight line between the start and the end of the second trajectory (T4) when the mask lies flat and is folded at the mirror plane of the substantially symmetrical regions, and L8b is the greatest value of a perpendicular distance between a point on the second trajectory (T4) and L7b.

With this arrangement, a slightly convex shape of the face part of the mask is provided. A small region extending towards the ears of the user is thus also covered by the mask, which may beneficially contribute to an additional sealing effect.

A 41th embodiment of the invention is directed to a wash-durable and reusable respiratory face mask for filtering air, preferably according to any one of the preceding embodiments, comprising a face part configured to cover at least the nose and the mouth of a head of a user and comprising one, preferably two, or more longish and preferably elastic fixing tapes which are separate from and attached to the face part and configured to allow fixing the face part to the head of the user when the mask is worn by the user, wherein a fixing tape, preferably all fixing tapes overlap with the face part in the longitudinal direction of the fixing tape by a length L4 of at least 0.4 cm, preferably at least 0.6 cm, more preferably at least 0.8 cm and most preferably at least 0.9 cm.

This arrangement allows for attaching the fixing tape to the face part across a region which is long enough to ensure a firm connection between the two different parts. In particular, a merit of this arrangement is that the mask is more tolerant of typical user actions such as tearing or pulling on the mask, which occurs frequently during ordinary use, for instance when the mask is put on or taken off the user's face According to a 42nd embodiment, in the preceding embodiment, a fixing tape is configured to go around the back side of the head when the mask is worn by the user.

This arrangement provides for a comfortable feeling for the user even if the mask is worn during a longer time, while the mask provides for proper sealing. In contrast, many prior art masks have their fixing tapes aligned around the ears of a user, which may create an unpleasant and painful feeling after prolonged use. Furthermore, less interference or impairment for the user is guaranteed by the arrangement of the present invention. In particular, if the users touch their face or ear region, the fixing means may be moved unintentionally, which may lead to a loss of sealing. The overlapping of the fixing means with the face part in combination with the placement of the fixing means around the back side of the head ensures that the mask or the face part is not torn into an unwanted direction. Instead, the mask or the face part is torn by the fixing tape into a specific direction to ensure a beneficial sealing while the mask is in use.

According to a 43rd embodiment, in any one of the 41st to 42nd embodiments, L4 is at most 5 cm, preferably at most 4 cm, more preferably at most 3 cm, even more preferably at most 2 cm and most preferably at most 1 cm.

According to a 44th embodiment, in any one of the 41st to 43rd embodiments, a seam connecting a fixing tape to the face part runs in the direction perpendicular to the longitudinal direction of the fixing tape, wherein the seam is preferably a bartack stitch seam comprising preferably a backtack stitch at each end of the bartack stitch seam.

This arrangement provides for a particularly firm connection of the fixing tape to the face part. The bartack stitch seam (see definition below) ensures a strong hold, and the backtack stitch prevents unravelling of this seam.

According to a 45th embodiment, in any one of the 41st to 44th embodiments, a seam connecting a fixing tape to the face part runs in the longitudinal direction of the fixing tape.

With this arrangement, the fixing mechanism of the different parts of the face mask is further reinforced, which is especially important for wash-durable and reusable masks. In particular, this arrangement makes the mask more tolerant of typical user actions such as tearing or pulling on the mask, for instance, when the mask is put on or taken off the user's face.

A 46th embodiment of the invention is directed to a wash-durable and reusable respiratory face mask for filtering air, preferably according to any one of the preceding embodiments, comprising a face part configured to cover at least the nose and the mouth of a head of a user and comprising one, preferably two, or more longish and preferably elastic fixing tapes which are separate from and attached to the face part and configured to allow fixing the face part to the head of the user when the mask is worn by the user, wherein the tape part overlaps with the face part in the longitudinal direction of the fixing tape and at least a portion of the fixing tape is enclosed by an element of the face part in the overlap area so that the portion is not exposed to the outside.

This arrangement protects at least a portion of the fixing tape in the overlap area from external impacts. This is particularly advantageous because the fixing tape is connected to the face part in the overlap area, wherein the connection may be sensitive for external impacts. Consequently, if there is no such enclosure of the fixing tape provided for, the connection may be adversely affected; for instance it may be damaged and/or destructed.

According to a 47th embodiment, in the preceding embodiment, the face part comprises a plane panel and the element of the face part that encloses the fixing tape is a longish elastic binding tape which is folded in its longitudinal direction and encloses an edge of the plane panel.

With this arrangement, the binding tape protects an edge of the plane panel and enhances its wear resistance against external impacts. Folding the binding tape in half has the further benefit that protection can be assured from both sides of the edge without the need for an additional part.

According to a 48th embodiment, in the preceding embodiment, the binding tape is connected to the plane panel by a seam.

This arrangement allows for a simple manufacturing process suitable for soft and flexible masks, since the seam does not inherit any solid or rigid elements that may prevent a pleasant wear experience for the user.

According to a 49th embodiment, in the preceding embodiment in combination with the 45th embodiment, the seam which connects the fixing tape to the face part and runs in the longitudinal direction of the fixing tape is at least a part of the seam which connects the binding tape to the plane panel.

With this arrangement, one seam is advantageously used for at least two purposes, namely, to protect the edge of the plane panel and to attach the fixing tape to the face part. Thus, the manufacturing process is simplified while protection means for wear resistance of the masks are substantially increased that support prolonged use of the mask. Furthermore, the fixing tape is enclosed by the binding tape and thereby its seam is also protected against any kind of impacts.

According to a 50th embodiment, in any one of the preceding embodiments, a tangent of a trajectory/section of a trajectory at the start/end of the trajectory/section of the trajectory is a straight line through two points on the trajectory/section of the trajectory, the two points having a distance of 4, 6, 8, or 10 mm from each other, wherein one of the points has a distance of at most 4, 2, or 1 mm from the start/end of the trajectory/section of the trajectory.

The tangents referred to herein are established by a straight line that connects two points. The two points are located on the trajectory, section or any other element of the mask whose tangent is to be defined. Furthermore, the two points are located in a distance to each other as described in this arrangement, to account for slight manufacturing inaccuracies. That is because manufacturing inaccuracies may occur and may lead to unwanted, undesired and/or unintended variations of the shape of trajectories, sections or any other elements of the mask. Thus, a tangent defined in a mathematical sense, e.g. with a distance of two points, wherein the distance of the two points converges to zero, would erroneously reflect these unwanted, undesired and/or unintended variations.

According to a 51st embodiment, in any one of the preceding embodiments, the start of a trajectory/section of a trajectory/edge with which a trajectory is associated is located upstream, and the end of a trajectory/section of a trajectory/edge with which a trajectory is associated is located downstream, with regards to the direction the trajectory.

With this arrangement, a trajectory, section, edge or any other element that goes from a point A to a point B is consequently directed from A to B, with start point A and end point B.

According to a 52th embodiment, in any one of the preceding embodiments, the mask comprises a nose clip positioned at a mirror plane of the face of the head and substantially spans the nose of the head, wherein the nose clip extends on both sides of the mirror plane by an extension having a length in the range of 2.0-5.5 cm, preferably 2.5-5.0 cm, more preferably 3.0-4.5 cm and most preferably 3.4-4.0 cm preferably when the mask lies flat and is folded at its mirror plane;
has a distance in the range of 0.0-2.0 cm, preferably 0.03-1.0 cm, more preferably 0.06-0.5 cm and most preferably 0.1-0.4 cm at any point of the nose clip to the upper end of a top edge of the mask;
is enclosed by an element of the mask, preferably by a longish elastic binding tape which is folded in its longitudinal direction so that the nose clip is not exposed to the outside, preferably such that relative movement of the nose clip and the binding tape in the longitudinal direction of the binding tape and/or in any direction perpendicular to the longitudinal direction of the binding tape is prevented;
is a means of free form deformation and substantial shape retention to approximately maintain a state pre-formed by the user; and/or
comprises or consists of one or more selected materials/parts from the group consisting of Low-Density Polyethylen (LDPE), double wire in a casing, light weight steel and suitable metals.

With this arrangement of the nose clip, a good fitting of the face mask to the nose and in general of the top edge of the face part is ensured. E.g., if the relative movement of the nose clip is restricted, this enhances the fitting and sealing, since the nose clip does not move inadvertently during use but maintains its optimal position.

According to a 53rd embodiment, in any one of the preceding embodiments, one or more hydrophilic agents and/or one or more antimicrobial agents are adhered to the mask.

The antimicrobial agents increase the protection of the user and other persons, because of their ability to kill at least some types of microorganisms, or to inhibit the growth or reproduction of at least some types of microorganisms. This provides for a self-sanitizing effect of the mask. The antimicrobial agents are preferably non-ionic or cationic, but not anionic. Anionic compounds do not bind well to textiles and can easily be removed, e.g., by salts. Cationic (acid) agents are believed to attack textile and therefore attach to it. Nanoparticles or antimicrobials in the form of nanoparticles are not preferred. According to the preferred embodiments of the invention, an antimicrobial agent is selected from quaternary Ammonium Organosilane compounds, metal, Polyglucosamine (Chitosan), Azole-based compounds, for instance Propiconazole, and Polyhexamethylene Biguanide (PHMB). The hydrophilic agents provide for a good absorption of the moist (e.g., in the form of aerosols) comprised in the exhaled air, which increases the wearing comfort. The comfort of wearing face masks increases when the material, preferably textile, constituting in particular the inner layer of a multi-layer filter material of the face mask is hydrophilic.

According to a 54th embodiment, in any one of the preceding embodiments, the mask is at least N90/R90/P90-rated, preferably at least N95/R95/P95-rated, and most preferably at least N99/R99/P99-rated.

The protection for the user is thereby increased. It is to be noted that the mask may or may not comprise a breathing valve, which allows unfiltered exhaled air to pass the mask. Although a valve beneficially reduces the exhalation resistance, it has the disadvantage that the environment, for instance other persons, are not protected.

According to a 55th embodiment, in any one of the preceding embodiments, the face part comprises at least one, preferably two, three or more layers.

The different layers can be provided with different properties to cater different needs and/or requirements in a flexible manner. This may be important for instance depending on the location of the layer. E.g., the outer layer may be water and/or stain repellent, while the inner layer may be hydrophilic for comfortable wearing. A sandwiched layer may be a non-woven fabric material for optimized filtering, while the layer on the outside may consist of more robust fabric.

According to a 56th embodiment, in any one of the preceding embodiments, at least one layer comprises a textile material and at least one layer comprises a particulate filter material.

With this arrangement, hydrophilic and/or antimicrobial agents can be bonded or adhered to the at least one layer comprising textile material, while at least one layer can perform the filter functionality. The bonding can be established in a manner to preserve the self-sanitizing effect even after several washes of the textile material.

According to a 57th embodiment, in any one of the preceding embodiments, the textile material is selected from the group consisting of woven, knitted, warp-knitted, and crocheted fabrics.

With this arrangement, the textile material is not selected from non-woven fabrics. Thus, the textile material is more robust, which allows it to be treated, e.g., by an exhaustion process, thereby increasing the adherence and bonding strength between the textile material and any agents applied to it. Also, since a not non-woven textile is more robust as compared for instance to a woven textile, it can serve as a protective layer for the filter material. In particular, an exhaustion process demands high mechanical forces that act on the textile, for instance due to jigger machines used therein. Therefore, a non-woven material is easily damaged during such an exhaustion process.

According to a 58th embodiment, in any one of the 56th to 57th embodiments, the textile of at least one layer is woven fabrics; and/or the textile of at least one other layer is selected from the group consisting of knitted, warp-knitted, and crocheted fabrics preferably knitted fabrics.

According to a 59th embodiment, in any one of the preceding embodiments, a layer comprising textile of woven fabrics is an outer layer exposed to the outside when the mask is worn by a user; and/or a layer comprising textile from the group consisting of knitted, warp-knitted, and crocheted fabrics preferably knitted fabrics is an inner layer exposed to the face when the mask is worn by a user.

With this arrangement, a more comfortable feeling is provided for the user, because the inner layer, which is exposed to the user's face, comprises textile which are stretchable. These fabrics have a more pleasant and soft feeling on the skin as compared to woven fabrics. Woven fabrics on the other hand are known to be more durable, thereby protecting the mask from external/environmental impacts.

According to a 60th embodiment, in any one of the 56th to 59th embodiments, the textile material is a cellulosic material comprising one or more selected from the group consisting of cotton, viscose, rayon, linen, hemp, ramie, jute, and combinations (blends) thereof preferably cotton.

Many antimicrobial agents such as PHMB and Chitosan adhere better to cellulosic textile, such as cotton, as compared to synthetic textiles. Furthermore, natural textiles, for instance textiles made of cellulosic material, are sufficiently biodegradable, thus resource-saving and ecological, and hydrophilic in nature.

Furthermore, they are more pleasant to wear than synthetic materials. Also, antimicrobial agents such as PHMB or Chitosan can react with functional groups of cellulosic material (for instance hydroxyl groups), which leads to strong covalent bonding.

According to a 61st embodiment, in any one of the 56th to 60th embodiments, the particulate filter material comprises or consists of a non-woven fabric, preferably fleece produced by melt blown method.

With non-woven fabrics, the particulate filtration efficiency can be established easily. A preferred particulate filter material is a non-woven N90, N95 or N99-rated fabric, in particular a non-woven N95-rated fabric. The particulate filter material may comprise or consists of one or more materials selected from the group consisting of polypropylene, polyacrylonitrile and hot melt adhesive, wherein the amount of polypropylene is preferably in the range of 60-100%, more preferably 80-98% and most preferably 94-96%.

According to a 62nd embodiment, in any one of the 56th to 61st embodiments, two layers of textile material are used as outer layers to sandwich the at least one layer of particulate filter.

With this arrangement of a sandwiching build-up of the multiple layers, with structured textile material as outer layers sandwiching the non-woven particulate filter material, the non-woven particulate filter material is protected from mechanical forces. Thus, the mask can be washed easily without adversely affecting, e.g., damaging its filter efficiency characteristics. This is because the rather fragile non-woven particulate filter material may break down if it is not protected from mechanical forces by woven (i.e, structured, not non-woven, such as knitted, crocheted, or woven in the narrower sense) textile material surrounding it. Also, the textile material sandwiching the particulate filter material layers may convey stain release capability and/or antimicrobial efficiency which are imparted to it by way of exhaustion. In exemplary embodiments, the textile material may be finished with at least one antimicrobial agent and/or at least one stain release agent.

According to a 63rd embodiment, in any one of the preceding embodiments, the face mask exhibits a bacterial filtration efficiency (BFE) of at least 99.9% (3 log), preferably of at least 99.99% (4 log), most preferably of at least 99.999% (5 log) as measured in accordance with test method ASTM F2101-2014 (test organism: Staphylococcus aureus (ATCC 6538); inoculum size: 6.5×10\hat{ }6 CFU/ml; flow rate: 1 Cu. Ft./min; aerosol particle size: 360.5 mm; distance: 15 cm).

According to a 64th embodiment, in any one of the preceding embodiments, the face mask exhibits a filter efficiency of at least 96%, preferably of at least 97%, most preferably 98% in accordance with the Sodium Chloride Aerosol NIOSH testing procedures TEB-APR-STP-0059, outlined in 42 CFR Part 84, the mask challenged with a concentration of Sodium Chloride of approximately 200 mg/m\hat{ }3.

According to a 65th embodiment, in any one of the preceding embodiments, the face mask exhibits an inhalation resistance of at most 23 mmH2O, preferably at most 18 mmH2O, more preferably at most 14 mmH20 and most preferably at most 10 mmH2O in accordance with the NIOSH testing procedures TEB-APR-STP-007, outlined in 42 CFR 84.180 loaded with 85 liters per minute airflow.

According to a 66th embodiment, in any one of the preceding embodiments, the face mask exhibits an exhalation resistance of at most 17 mmH2O, preferably at most 13 mmH2O, more preferably at most 10 mmH20 and most preferably at most 7 mmH2O in accordance with the NIOSH testing procedures TEB-APR-STP-003, outlined in 42 CFR 84.180 loaded with 85 liters per minute airflow.

With the above arrangements of the 62nd to 65th embodiments, the mask underlying the present invention fulfills important and stringent safety protocols and can be supplied to users in order to effectively protect the users and the environment, e.g., other persons, from possible diseases that may arise due to transmission of airborne particles and microbial pollution.

In the following, preferred embodiments underlying the present invention are described, by way of example only, with reference to the accompanying drawings. Several advantages are apparent in these embodiments as well as in the above-described summary of the invention. Without being bound to completeness, these advantages comprise in a non-exhaustive list: The mask may conform to the curved contour of the human face and provide for an effective air seal at the edges of the mask. Thus, the user is protected from inhaling and exhaling unfiltered air. The air seal may be sufficiently ensured even when the wearer talks, shouts, coughs, sneezes or changes facial expressions that result in unnatural contours of the face or makes grimaces. To achieve this conformity of the mask to the human face, the geometric arrangement of the edges of the mask are formed to match the human's face contour properly, in particular the human's face irrespective of the user's regional or ethnic origin or facial features. The edges follow trajectories formed to align with the curved contour of the user's face, in particular between the bridge of the nose, the region below the eyes and the cheekbones. This is challenging because the surface of the face between the bridge of the nose and a cheekbone is not a flat plane. Instead, this surface is subject to high 3D shape variations. The top edge of the mask is therefore advantageously shaped to fill in the valleys formed along the trajectory of the top edge. A further advantage of the shape of the mask may be the prevention of surplus material, e.g. textile or any kind of fabric used for the manufacturing or production of the mask, that would otherwise be wasted. This also entails economic and ecological advantages. The mask can further be carried easily in pockets or small bags due to its flexibility and softness and the ability to be folded conveniently to the user's needs. In particular, mechanical forces can act on the mask without destroying the mask or without adversely affecting the functionality of it. In addition, the mask may form an air pocket in the region in front of the mouth, which does not collapse or shrink, or which does not substantially change its volume if the user exhales or inhales. This is achieved, among another factors, by the front seam and the specifications of the angles of the front edge. Also, the fixing tapes may ensure a good fixation of the mask to the user's face. This may also be achieved by the overlapping of the fixing tapes with the face part in the longitudinal direction of the fixing tape and by way of the fixation around the head of the user.

### BRIEF DESCRIPTION OF THE DRAWINGS

FIG. 1: is a front view of the face mask according to the invention when worn by the user

FIG. 2a: is a side view (cut A-A of FIG. 1) of the face mask showing different layers of the face mask in one embodiment

FIG. 2b: is a side view (cut A-A of FIG. 1) of the face mask showing different layers of the face mask in another embodiment

FIG. 2c: is a front view of the face mask mounted on a user's head and indicating the sealing element covered by the face part

FIG. 3a: is a side view of the face mask showing various edges, trajectories, and sections

FIG. 3b: is a side view of the face mask 100 showing various angles and tangents

FIG. 3c1: is a side view of the face mask showing various lengths and perpendicular distances

FIG. 3c2: is a side view of a prior art face mask showing the various lengths and perpendicular distances of the prior art face mask

FIG. 3d1: is a side view of the face mask according to the invention showing various angles and their values

FIG. 3d2: is a side view of a prior art face mask showing various angles and their values of the prior art face mask

FIG. 3e: is a side view of the face mask according to the invention showing details of the top edge of the face mask

FIG. 4a: is a side view of the face mask worn by the user and showing the distance to the mouth and the fixing tapes

FIG. 4b: is a side view of a prior art face worn by the user and showing the distance to the mouth and the fixing tapes

FIG. 5: is a side view of the face mask according to the invention worn by the user and showing the fixing tapes, the binding tapes and the nose clip.

Throughout the present drawings and specification, the same reference numerals refer to the same elements. The drawings may not be to scale, and the relative size, and depiction of elements in the drawings may be exaggerated for clarity, illustration, and convenience. However, the relative proportions of each drawing may reflect the real proportions unless otherwise stated.

### Definitions

Unless otherwise stated, the term “substantial” or “substantially” as used in the present context may be understood to a great or significant extent or for the most part or essentially.

In the context of the present invention, “antimicrobial” relates to the ability to kill at least some types of microorganisms, or to inhibit the growth or reproduction of at least some types of microorganisms. Said term relates to any compound, agent, product or process that is harmful to one or more microorganism as used in the context of the present invention. Preferably, the one or more microorganisms get destroyed or inactivated by the “antimicrobial” product or process. By “antimicrobial agent” is meant any substance or combination of substances that kills, inactivates or prevents the growth of a microorganism. The terms “microorganism” and “microbe”, which are used interchangeably in the context of the present invention, are defined to comprise any organism too small to be seen by the unaided eye, such as, especially, single-celled organisms or viruses.

In the context of the present invention, the terms “textile” and “textile material” relate to a flexible material consisting of fibers, or a network of natural and/or artificial/synthetic fibers, such as a yarn or a fabric. The material may be in its natural or processed or even finished form.

“Tangents” are defined as a straight line that touches a curve at a point, for instance a section of an edge, an edge or a trajectory, but does not cross that curve at that point. Tangents at a certain point or location on a curve used herein are to be understood to have substantially the same form when the point is varied along the curve by +/−0.1 cm. This should help to avoid misinterpretations of tangents due to local shape deformations of the mask within the context of the present invention. These misinterpretations may arise if the tangent was applied in a mathematical sense, which would reflect even the slightest manufacturing inaccuracies, which is not intended to be applicable herein. A tangent at an end of a section as used herein is to be understood to be located away from the end of the section by 0.05-0.5 cm.

The term “convex” as used in the present invention is to be understood as having an outline or surface curved like the exterior of a circle or sphere. Also, in terms of a convex polygon for instance, is to be understood as not having any interior angles greater than 180°.

The term “concave” as used in the present invention is to be understood as having an outline or surface curved inwards like the interior of a circle or sphere. Also, in terms of a concave polygon for instance, is to be understood as having at least one internal angle that is greater than 180 degrees.

A “bartack” or “bartack seam” is a condensed zigzag seam used for reinforcement or anchoring of textile or fabrics. A “backtack” or backtack seam” is a straight single-needle seam (or actually just 3-4 stitches), that prevents the main seam from unravelling. For instance, the manufacturer backs up a few stitches once the main seam is complete.

“Particulate filtering material” or “particulate filter material” trap particles, such as dust or aerosols and other droplets which may carry microorganisms, out of the breathing air. Particulate filtering materials may be tested and classified according to their filter efficiency towards the smallest sized particle. Ninety-five percent filtration of particles is the minimum level that is stipulated by the National Institute for Occupational Safety and Health (NIOSH) in the United States for a “95-rating”, according to NIOSH-42CFR84. The particulate filtering materials are further classified according to their oil resistance. In this regard, “N” indicates no oil resistance, “R” indicates slight oil resistance, and “P” indicates strong oil resistance (for example: a N95-rated, R95-rated or P95-rated particulate filtering material).

When the user stands upright and has their head directed straight to the front, the “vertical height” is measured from the ground in a line extending vertical from the ground, the vertical line forming a perpendicular angle to the ground. The “vertical direction” is directed from the ground upwards, wherein the direction is perpendicular to the ground.

### Angle Definitions

A1201: An acute angle between the substantially straight lines formed by the first 121 and second sections 122 of the trajectory T1 of the front edge 120 as discussed below.
A1202: An acute angle between the substantially straight lines formed by the second 122 and third sections 123 of the trajectory T1 of the front edge 120 as discussed below.
A1203: An acute angle between the substantially straight line of the third section 123 and the tangent (K1201) of the fourth section at the start of the fourth section 124 of the trajectory T1 of the front edge 120 as discussed below.
A1204: An acute angle between the substantially straight line of the third section 123 and the tangent (K1202) of the fourth section at the end of the fourth section 124 of the trajectory T1 of the front edge 120 as discussed below.
A1401: An acute angle between the tangent (K1401) of the first section 141 at the start of the first section 141 and the tangent (K1403) of the second section 142 at the end of the second section 142 of the trajectory T2 as discussed below.
A1402: An acute angle between the tangent (K1403) of the second section 142 at the end of the second section 142 and the tangent (K140m) of the first section 141 at any point of the first section 141 of the trajectory T2 as discussed below.
A1403: An obtuse angle between the tangent (K1402) of the second section 142 at the start of the second section 142 and the tangent (K1403) of the second section 142 at the end of the second section 142 of the trajectory T2 as discussed below.
A1501: An obtuse angle between the tangent (K1501) of the trajectory (T3) at the start of the trajectory (T3) and the tangent (K1502) of the trajectory (T3) at the end of the trajectory (T3) as discussed below.
A150m: An obtuse angle (A150m) between the tangent (K150m) of the trajectory (T3) at the midpoint of the trajectory (T3) and the tangent (K1501) of the trajectory (T3) at the start of the trajectory (T3) as discussed below.
A1601: An angle facing the face part (105) and formed between the tangent (K1502) of the trajectory T3 of the bottom edge 150 at the end of the trajectory T3 of the bottom edge 150 and the tangent (K1601) of the trajectory T4 of the rear edge 160 at the start of the trajectory T4 of the rear edge 160 as discussed below.
A1602: An angle facing the face part 105 and formed between the tangent (K1403) of the trajectory T2 of the top edge 140 at the end of the trajectory T2 of the top edge 140 and the tangent (K1602) of the trajectory T4 of the rear edge 160 at the end of the trajectory T4 of the rear edge 160 as discussed below.

### Length Definitions

L1: Is the smallest distance between the mouth section 128 and the foremost contact point of the lips of the closed mouth when the mask is worn by the user as discussed below.
L2a: Is the length of a straight line between the start and the end of the trajectory (T1) when the mask is worn by the user as discussed below.
L2b: Is the length of a straight line between the start and the end of the front edge 120 when the mask lies flat and is folded at its mirror plane as discussed below.
L3: Is the greatest value of a perpendicular distance between a point on the trajectory (T1) of the front edge 120 and L2b when the mask 100 lies flat and is folded at its mirror plane as discussed below.
L5b: Is the length of a straight line between the start and the end of the fourth section 124 when the mask 100 lies flat and is folded at its mirror plane as discussed below.
L6b: is the greatest value of a perpendicular distance between a point on the fourth section 124 and L5b when the mask 100 lies flat and is folded at its mirror plane as discussed below.
L7b: Is the length of a straight line between the start and the end of the trajectory T4 of the rear edge 160 when the mask lies flat and is folded at its mirror plane as discussed below.
L8b: Is the greatest value of a perpendicular distance between a point on the trajectory T4 of the rear edge 160 and L7b when the mask 100 lies flat and is folded at its mirror plane as discussed below.
L1401: Is the length of a straight line between the start and the end of the top edge 140 when the mask lies flat and is folded at its mirror plane as discussed below.
L1402: Is the greatest perpendicular distance between a point (P140m) on the trajectory (T2) of the top edge 140 and L1401 when the mask 100 lies flat and is folded at its mirror plane as discussed below.
L1403: Is the distance between a point (P140m) on the trajectory (T2) of the top edge 140 and the trajectory T2 and/or the end of the top edge 140 measured in the negative-Y-direction, wherein the negative-Y-direction is the direction from the start of the front edge 120 to the end of the front edge 120 of the face part 105 when the mask 100 lies flat and is folded at its mirror plane as discussed below.

### Miscellaneous Definitions

T1: Trajectory formed by front edge
T2: Trajectory formed by top edge of symmetrical region 110a
T3: Trajectory formed by bottom edge of symmetrical region 110a
T4: Trajectory formed by rear edge of symmetrical region 110a
M1: Symmetrical mirror plane of the face
P140m: Point in which the second section 142 extends from the first section 141, located on the trajectory (T2) with the greatest perpendicular distance between the point (P140m) and a straight line connecting the start and the end of the trajectory (T2).

### DETAILED DESCRIPTION

In the following, exemplary embodiments of the present invention are described in more detail. However, the present invention is not limited to these, and a multitude of other embodiments are applicable without departing from the spirit of the invention.

### 1. Front Edge with a Continuous Seam

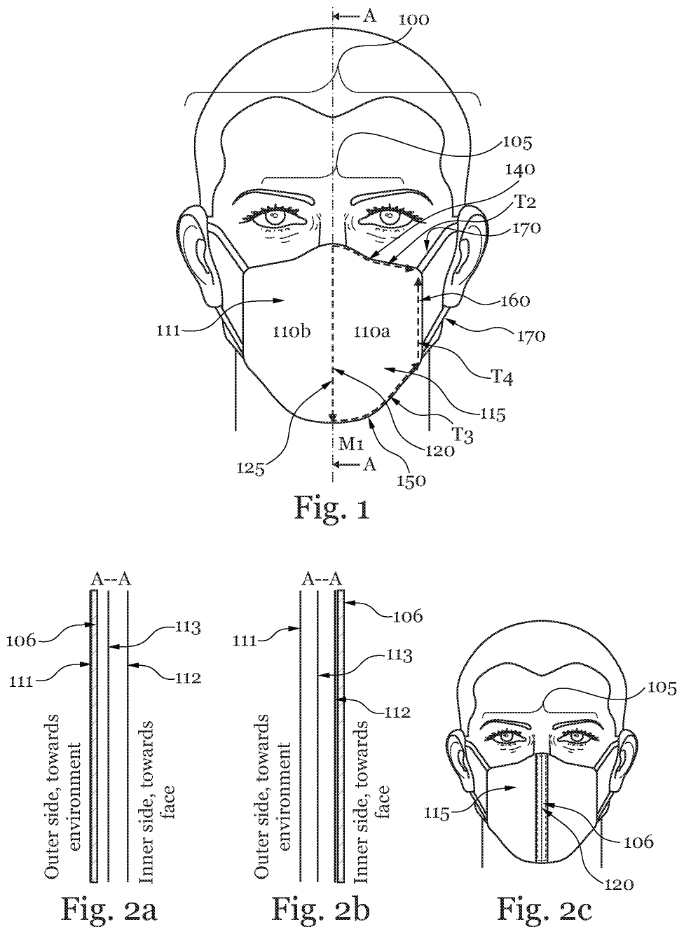

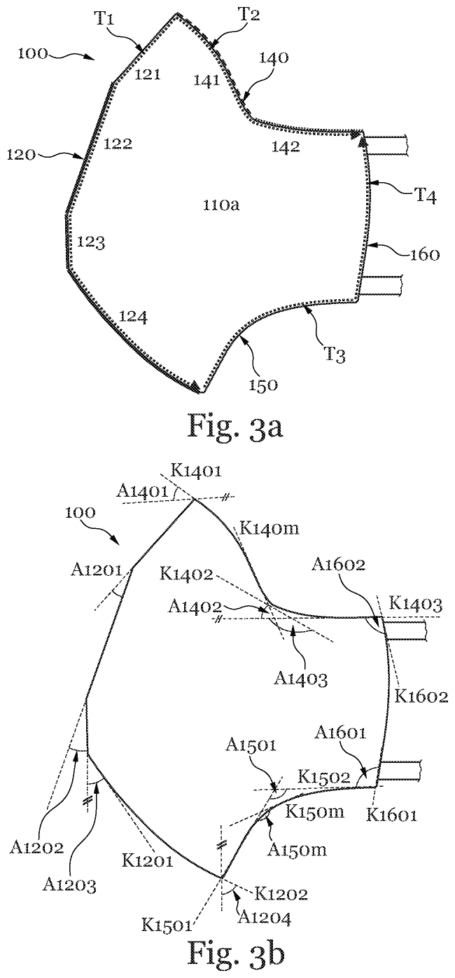

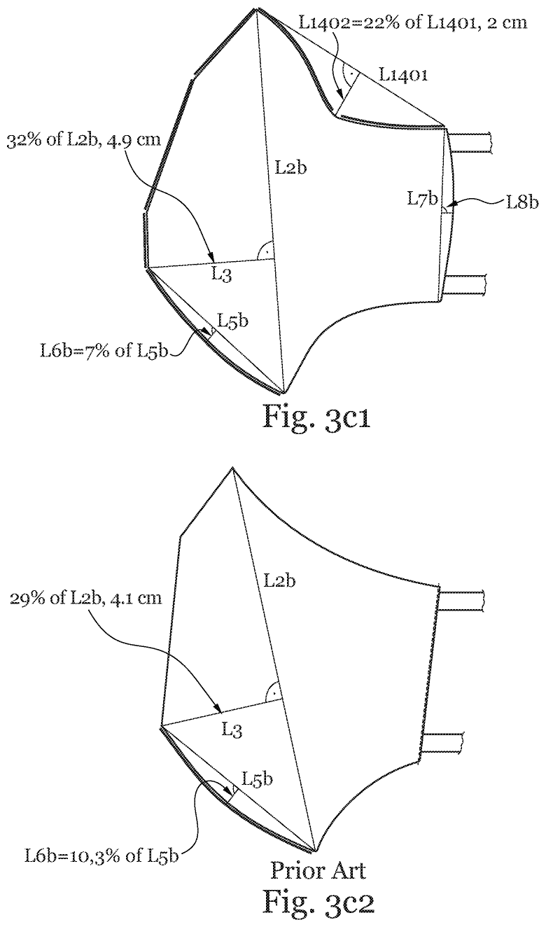

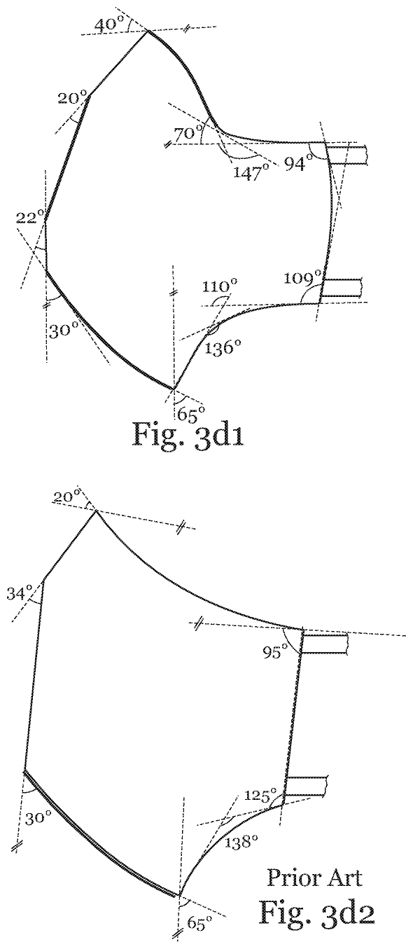

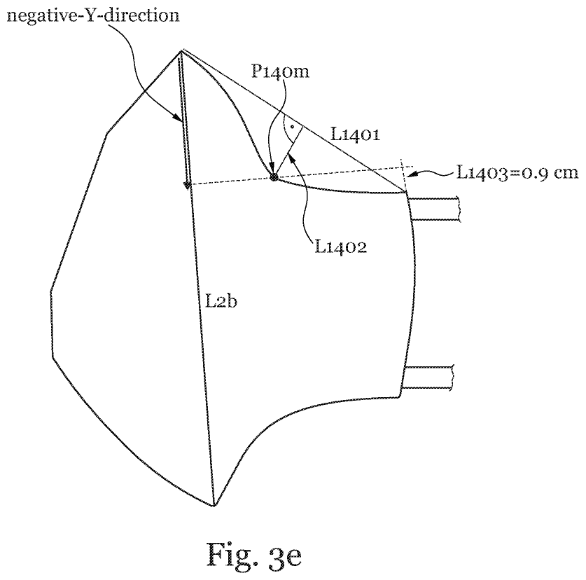

FIG. 1 shows a front view of a user wearing a wash-durable and reusable respiratory face mask 100 according to an exemplary embodiment of the invention. The face mask 100 comprises a face part 105 that is configured to cover at least the nose and the mouth of a head of a user, and further comprises two substantially symmetrical regions 110a, 110b. The mirror plane M1 of the face of the user serves to define the symmetrical regions 110a, 110b and may thus be used to virtually split the face part 105 into its two symmetrical regions 110a, 110b. At the border of these symmetrical regions 110a, 110b, a front edge 120 is located, which forms a trajectory T1 which runs, when the mask 100 is worn by the user, from the bridge of the nose of the head to the chin of the head (see also FIG. 3, which is a side view of FIG. 1 when the mask lies flat and is folded at its mirror plane). The front edge 120 comprises a seam 125 which runs continuously along the trajectory T1. The seam 125 can be used to attach at least two parts of the face part 105 but may also be present without the technical functionality of connecting two parts of the face part 105. However, the seam 125 typically joins two or more layers of fabric, or other materials and to hold those together with stitches. When the mask 100 is worn by a user, slight deviations of the trajectory T1 and the symmetrical mirror plane M1 of the face of the user may occur. This can happen for instance when the user or another person pulls on one region 110a, 110b or any kind of force acts on the mask 100 or the face part 105 in a way that does not match the normal usage mode of the face mask 100. Therefore, the distance of a point on the trajectory T1 to the symmetrical mirror plane M1 of the face of the user may be at most 2.5 cm, preferably at most 2.0 cm, more preferably at most 1.5 cm and most preferably at most 1.0 cm, without deviating from the exemplary embodiment of the underlying invention. The seam 125 is preferably a single stitch, single ply constructed or double-stitched seam 125. However, any kind of seam may be applied, which includes at least all of the seam types according to the seam type classification and terminology standard ISO 4916:1991, which is hereby incorporated by reference. The manufacturing process is simplified and/or facilitated by using a single stitch seam. If the two pieces of a face part are stitched together, as it is the case in an embodiment of the present invention, they have the appearance of a butterfly. Thus, this type of stitching is also called single needle butterfly stitch. The continuous seam provides smoothness of the front edge and substantially prevents or limits the establishment or occurrence of sharp corners on the front edge, which may be present in the prior art due to seams that are not continuous and therefore have endings on the front edge. More importantly even, this configuration of the seam 125 of the front edge 120 of the mask 100 contributes to stabilizing the pocket which is formed by the face part in front of the mouth of the user. Thus, a desired distance between the face mask 100 or the face part 105 and the mouth of the user is better maintained and in particular capable of withstanding forces exerted on it during an intake of breath by the user.

With reference to FIGS. 2a and 3a, in a preferred embodiment, the mask 100 comprises three layers 111, 112, 113. The inner layer 112 comprises fabrics of knitted cotton textile, the outer layer 111 comprises fabrics of woven cotton textile, and the third layer 113 comprises particulate filter material, e.g., non-woven fabrics or melt blown fleece. As can be seen in FIG. 2a, the third layer 113 is sandwiched by the inner layer 112 and the outer layer 111. The particulate filter material of the third layer 113 effectively filters the inhaled and exhaled air and the antimicrobial agents that are adhered to the textile material of the remaining layers sanitize the air, e.g., kill microorganisms and viruses.

### 2. Face Part Layers Divided into Two Pieces

FIG. 1 also shows that the face mask 100 comprises an outer layer 111 according to an embodiment of the invention, wherein the outer layer in is divided into two pieces along the border of the symmetrical regions 110a, 110b, and thereby also along the symmetrical mirror plane M1 of the face. The outer layer in is exposed to the environment when the mask 100 is worn by the user. FIG. 2 shows the outer layer 111 in an exemplary side view A-A of FIG. 1. The two pieces are separated from and connected to each other. The connection means is in one embodiment achieved by the seam 125 that goes along the trajectory T1, which runs, when the mask 100 is worn by the user, from the bridge of the nose of the head to the chin of the head. The trajectory T1 is formed by the front edge 120.

Furthermore, the face part 105 comprises a second, inner layer 112 according to an embodiment of the invention, wherein the inner layer 112 is divided into two pieces along the border of the symmetrical regions 110a, 110b, and thereby also along the symmetrical mirror plane M1 of the face. The two pieces are separated from and connected to each other. The connection means is a seam, which is but one example suitable for the use in an embodiment of the invention. FIG. 1 and FIG. 2a also show in an exemplary embodiment that the outer layer 111 comprises a sealing element 106 overlapping the border of the regions 110a, 110b. In addition, or instead, the sealing element 106 may be comprised by the inner layer 112 according to the exemplary embodiment of FIG. 2b. FIG. 2c shows both embodiments in a front view. The sealing element 106 of this exemplary embodiment is glued to the outer layer 111. However, different attachment means are possible. The sealing element 106 has a thickness in the range of 0.05-1.0 mm, preferably 0.08-0.6 mm, more preferably 0.1-0.4 mm and most preferably 0.12-0.2 mm. Depending on the material/parts used for the sealing element the thickness may vary. For instance, if silicon is applied as a material, the thickness may be greater than 1.0 mm. The sealing element 106 is a thin element, comparable to a foil or tape which sticks to the layer, wherein the width and length dimensions are much larger than its thickness. The width of the sealing element 106 is in the range of 0.4-4.0 cm, preferably 0.6-3.5 cm, more preferably 0.8-3.0 cm and most preferably 1.0-2.5 cm, and the length is preferably such that it can cover the complete continuous seam 125 which connects the two pieces of the outer layer together. The thickness of the sealing element 106 is in the range of 0.05-1.0 mm, preferably 0.08-0.6 mm, more preferably 0.1-0.4 mm and most preferably 0.12-0.2 mm. The sealing element 106 comprises or consists of one or more selected materials/parts from the group consisting of seam sealing tape, Silicon, liquid stripe and Polyurethan, preferably the sealing element 106 is a seam sealing tape. The sealing element 106 is flexible and durable, and even though it is lightweight, it is preferably waterproof and seals tightly, which guarantees that no dirt, water, or other elements will leak through and interfere with the bond or seam, which is covered by it. Furthermore, in an exemplary embodiment of the invention, the sealing element 106 fulfills the adhesion tape test according to DIN EN ISO 10683 and water resistance tests similar to DIN 18542, DIN EN ISO 2812-1, DIN EN ISO 2812-1 or DIN EN ISO 16925. Due to these advantageous characteristics, the sealing element 106 is non-permeable for liquids, aerosols and/or air. The permeability to liquids, aerosols and/or air is substantially lower than that of layers 111, 112 of the face part 105. It therefore seals the border of the regions 110a, 110b. This increases safety for the user and the surrounding users because leakage of air without being filtered by the mask 100 is prevented.

FIG. 2 also shows a third layer 113, which in the exemplary embodiment of the invention is sandwiched by the inner layer 112 and the outer layer in of the face part 105. The third layer 113 is preferably a single-piece and/or non-woven fabric that extends in both regions 110a, 110b. Thus, there is no seam at the border of the two regions 110a, 110b of the third layer 113, and it is therefore best suited for filtering air which enters and exists the mask, for instance by inhaling and exhaling of the user.

With the arrangement of the layers of the previously described embodiment, the third layer 113 is protected by the outer layer 111 and the inner layer 112. This is in particular beneficial for the washability, durability and reusability of the mask 100, since the non-woven material of the third layer 113, which is suited for filtering the air, is protected against external mechanical, chemical or any other kind of damage during the washing procedure.

### 3. Front Edge

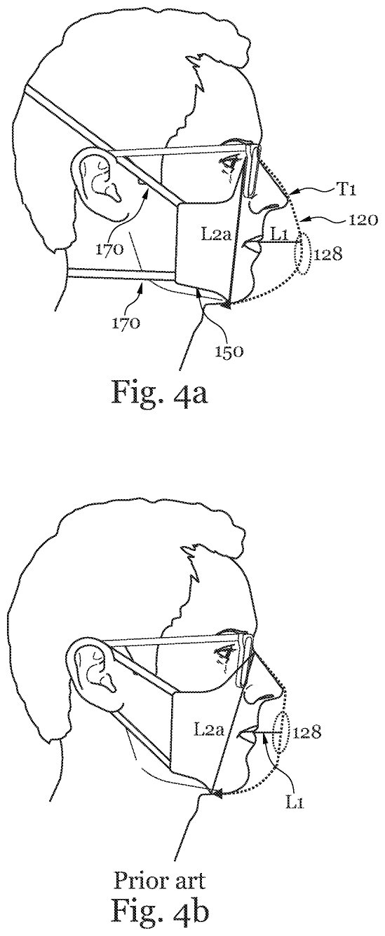

FIGS. 1 and 3 show the shape of the front edge 120 of the face mask 100 in a front and a side view, respectively, in a preferred embodiment of the invention. The shape of the front edge 120 is designed to overcome at least part of the limitations of prior art addressed above. It improves the fit of the mask 100 when the mask 100 is worn by a user and provides for a better alignment with the general silhouette of a human's face. The front edge 120 forms a trajectory T1, which runs, when the mask 100 is worn by the user, from the bridge of the nose of the head to the chin of the head, substantially at the symmetrical mirror plane (M1) of the face. The shape is described by different sections. In the embodiment of FIG. 3, four sections are shown. However, the invention is not limited to this configuration, and other embodiments may comprise at least two sections. The first section 121 forms a straight line and covers at least part of the nose, when the mask 100 is worn by a user. The second section 122 is a straight line as well, starts at the end of the first section and extends from it in an angle A1201 of preferably 200 (see angle definition above). The angles of a preferred embodiment are further summarized in Table 4 below in comparison to the prior art. The transition point from the first section 121 to the second section 122 is substantially at the middle of the nose, see FIG. 4. The third section 123 of the trajectory T1 is a substantially straight line as well and extends from the second section 122 in an angle A1202 of preferably 22° (see angle definition above). The length of this third section is typically 2 cm. The start of the third section is in the domain of the trajectory T1 in front of the mouth, typically at the vertical height (for “vertical height”, see definition above) of the upper lip, see FIG. 4. The fourth section 124 of the trajectory T1 is a line that is not straight but has a continuous convex bend or is curved and extends from the third section 123 in an angle A1203 (see angle definition above) of preferably 30°. The length of this third section is typically about 2 cm. The start of the third section 123, and thus the end of the third section 123, is in the domain of the trajectory T1 in front of the mouth, typically at a vertical height (for “vertical height”, see definition above) below the lower lip of the user, see FIG. 4. The angle A1204 (see angle definition above) at the end of the fourth section 124 is preferably 65°. The bend of the fourth section 124 is in a further embodiment specified by using length L5b and L6b (see length definition above). L6b is preferably in the range of 7% of L5b (see Table 1).

TABLE 1
Lengths of fourth section 124 of front edge 120

| Parameter | Present application | Prior art |
|---|---|---|
| L5b (non-dimensional) | 6.31 | 5.57 |
| L6b (non-dimensional) | 0.44 | 0.57 |
| L6b/L5b | 7.0% | 10.3% |

The convex bend of the fourth section 124 in this embodiment supports the alignment of the mask 100 or the face part 105 with the chin of a user and thus improves the prior art masks. The benefit of this arrangement is that the tangent at the end of the fourth section 124 of the trajectory T1 formed by the front edge 120 matches the curvature of the chin of the user. Furthermore, the overall shape of the front edge takes into account a reduction of fabric remnants and thereby improves manufacturing. Any angle variation that occurs on the sections (121-124) of the trajectory T1 or on the trajectory T1 formed by the front edge 120 along the path of the trajectory T1 is limited to a maximum value, e.g. at most 28-32°, on a minimum pathlength, e.g. at least 0.5-0.8 cm. In such an embodiment of the present invention, the visual acceptance and attraction to the face mask is increased as opposed to a mask that has sharp angle variations and thus sharp corners in the front edge.

### 4. Distance to the Mouth

FIGS. 4a and 4b show the distance L1 from the mouth section 128 of the front edge 120 to the lips of the user in one embodiment of the invention when the mask is worn by the user. FIGS. 3c1 and 3c2 show the distance L3 of the front edge 120 of the face mask 100 from the straight line L2b in one embodiment of the invention when the mask lies flat and is folded at its mirror plane. The mask 100 of these embodiments maintains a certain distance L1 or L3 (see length definition above) shown in Table 2 below. The drawings as well as the Table show the difference over a prior art mask.

TABLE 2
Distances of mouth section 128 of front edge 120 to mouth
of a user, for the definition of the lengths see above

| Parameter | Present application | Prior art mask |
|---|---|---|
| L1 | 4.5 cm | 2.7 cm |
| L1/L2a | 29% | 19% |
| L3 | 4.9 cm | 4.1 cm |
| L3/L2b | 32% | 29% |

The configurations of this embodiment have the advantage that the material of the mask 100, for instance the textile material, is prevented from getting in touch with the mouth when the user inhales or otherwise changes the facial expression, due to the increased distance from the front edge to the mouth. This is beneficial for speaking and any other activity performed with the mouth and provides the user with more comfort, because the mask touching the mouth is unpleasant.

### 5. Top Edge

FIG. 1 depicts the top edge 140 of the face part 105 of the mask 100 along with the trajectory T2 that it forms in a front view. FIG. 3 illustrates the same edge in a side view. The trajectory T2 has two sections according to an embodiment of the present invention. However, the invention is not limited to two sections. Multiple sections can be defined along the trajectory, as the skilled person is aware of several strategies to identify sections on any trajectory. The trajectory T2 runs, when the mask 100 is worn by the user, from the nose of the head towards an ear of the head. The first section 141 covers at least part of the nose when the mask (100) is worn by the user and forms a substantially convex bend. The second section 142 extends from the first section and forms a concave bend. The convex bend has an angle A1401 (see angle definition above) at the start of the first section 141 of 400 and a maximum angle of 70° along the path of the trajectory T2, see FIG. 3d1. The angles of a preferred embodiment are summarized in Table 4 below in comparison to the prior art. The bend of the second section 142 is less pronounced than the one of the first section 141. The transition point from the first to the second section is located where the convex bend changes into a concave bend. This point is further specified as P140m in one embodiment in FIG. 3e and described as the point P140m located on the trajectory T2 with the greatest perpendicular distance L1402 between the point P140m and a straight line L1401 connecting the start and the end of the trajectory T2. In this embodiment, L1402 has a length of 2 cm, which represents 22% of the length L1401, see Table 3.

The shape of the top edge 140, by virtue of the present embodiment, provides a tight and smooth fit and seal around the region of the nose and the eyes and ensures that the mask covers the relevant portions of the face to prevent inhaling or exhaling of unfiltered air. The region of the nose and the eyes of a face of a user is dominated by 3D shape variations of the surface of the user's face, in particular in the direction of the trajectory T2. A good seal between the mask and the face is therefore a major challenge. The convex-concave shape of the top edge 120 is well suited to cope with this challenge and supports a flush sealing. The convex shape of the first section 141 in combination with the starting location of the first section 141 at the bridge of the nose ensures that the top edge 140 of the mask 100 covers a region of a face that has less pronounced 3D shape variations. In contrast, if the first section was a straight line, it would not allow to follow the 3D shape variations of the surface of the face and would thus not create a tight sealing. Also, if the top edge started at a nose portion at a vertical height (for “vertical height”, see definition above) lower than the bridge of the nose (e.g., as shown for the prior art mask in FIG. 4b), the 3D shape variations of the surface of the user's face would be more pronounced in the direction of the trajectory T2, and sealing could be accomplished as well. Thus, a further benefit of the embodiment described above is that the top edge starts at the bridge of the nose, in particular at an upper portion of the nose, rather than for instance closer to the tip of the nose. Due to the concave shape of the second section of the top edge 140, a cutout or cutout pocket for the eyes is established. This has the effect that the mask maps the curvature of the user's face better while providing for a good seal. In the prior art mask, glasses or spectacles that a user potentially wears may become steamed up or fogged due to air leaking through at least some of the regions of the face of pronounced 3D shape variations close to the side of the nose. The pronounced convex-concave shape of the top edge 140 has the further advantage to better fit and better model a 3D geometry like a human's face by a 3D mask 100 or face part 105, which is manufactured out of a flat 2D textile and therefore incorporates substantial improvements for the production of this mask. The shape of the top edge 120 has the further advantage that glass wearers do not have to cope with steamy glasses due to the fact that the top edge starts at the bridge of the nose and the natural position of the glasses is at a position of the nose that is closer to the nose tip than the start of the top edge, see FIG. 4a, compared to prior art FIG. 4b. Thereby, the glasses sit on top of the mask, even further providing a tight sealing due to mechanical forces acting on the mask towards the face of the user. In particular, this embodiment of the present invention also ensures that the glasses or spectacles worn by a user substantially do not become steamed up or fogged as compared to the prior art mask described above. This beneficial effect would even be achieved, if the glasses were not sitting on top of the mask, but on the skin, for instance at the bridge of the nose. This is, because the shape of the mask in this embodiment substantially prevents air from leaking at least through the regions close to the eyes and the nose and thereby preventing potentially warm and exhaled air by the user from getting in contact with the glasses. This effect may also be reasoned by the combination of a multitude of the individual features of the mask according to this embodiment.

TABLE 3
Lengths of the top edge 140; for the
definition of the lengths see above

| Parameter | Present application | Prior art |
|---|---|---|
| L1402 | 2 cm | 0.4 cm |
| L1402/L1401 | 22% | 0.5% |

The embodiment of the top edge in FIG. 3e has a distance or length L1403 of 0.9 cm from the end of the trajectory T2, which represents the end of the top edge 140. This distance is measured in the negative-Y-direction, which is defined in the embodiment in FIG. 3e as the direction from the start of the front edge 120 to the end of the front edge 120 of the face part 105. However, other distances or lengths L1403 are possible without contravening the scope of the present invention.

### 6. Bottom Edge

FIG. 1 shows the bottom edge 150 of the face part 105 of the mask 100 in one embodiment of the invention. FIGS. 3a-3d2 give further details of one embodiment of the bottom edge 150, also in comparison to a prior art mask. The comparison of the angles of the bottom edge 150 is shown in FIGS. 3d1 (present embodiment) and 3d2 (prior art mask). The difference in the angles is appreciated by the user, since it provides a better fit, especially in the region of the chin towards the jawbone. This is especially apparent when comparing FIGS. 4a (present embodiment) and 4b (prior art mask). In this embodiment, the cheek region of the face is covered by the mask to a greater extent. Therefore, a better sealing can be established, because the region of the cheek closer to the mouth is subject to higher and more frequent shape variations when the user speaks or changes certain facial expressions.

The angles of a preferred embodiment are further summarized in Table 4 below in comparison to the prior art.

### 7. Pre-Stretched Edge

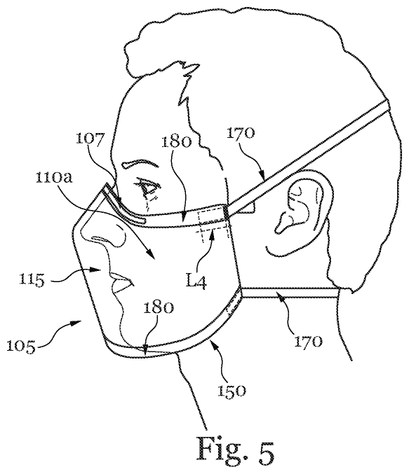

FIG. 5 shows the longish and elastic binding tape 180 in an embodiment of the present invention that is comprised by the bottom edge 150 of the face mask 100. However, other edges of the mask may also comprise a longish and elastic binding tape 180, in particular the top edge 140 (not shown). To ensure a tight seal and at the same time a comfortable feeling for the user, the bottom edge 150 is manufactured in the following way: the binding tape 180 is elongated by 10% in the longitudinal direction, however, different amounts may also be applicable within the scope of the present invention. Then the binding tape 180 is attached to the bottom edge 150 with a seam. This pre-stretching of the binding tape 180 ensures that when the mask is worn by a user, a natural look of the material without the appearance of a large number of folds is established. That is because in use mode, an expansion of the binding tape 180 of the bottom edge 150 occurs which brings the material of the face part 105 back in is original shape and position. Furthermore, the pre-stretching ensures that the edge streamlines well with the shape of the user's face, in particular with the shape of the chin. Thereby the pre-stretching supports a flush sealing. In particular, a good balance of a pre-stretching that is not too strong and not too loose is established. In this arrangement, the pleasant feeling of the mask also supports easy breathing for the user even during prolonged use.

### 8. Rear Edge

FIG. 1 shows an embodiment of the rear edge 160 of the face part 105 of the face mask 100. FIGS. 3a-3d2 show further details and a comparison to a prior art mask. The comparison of the angles of the rear edge 160 is shown in FIGS. 3d1 (present embodiment) and 3d2 (prior art mask). The difference in the angles provides a better fit to the user's face. Table 4 below lists the differences between the angles of an embodiment of the present invention and the prior art. The angle A1601 has a value of 109° and is sufficiently smaller than the corresponding angle of prior art mask. This also supports a more structured and clean appearance of the mask, which is appreciated by the user. The angles of a preferred embodiment are further summarized in Table 4 below in comparison to the prior art.

### 9. Overlapping Fixing Tape

FIG. 5 shows an embodiment of the longish and preferably elastic fixing tapes 170 of the face mask 100. Two fixing tapes 180 overlap with the mask 100. The fixing tapes 170 fix the mask 100 to the user's head. For that purpose, the fixing tapes 170 may go around the back side of the head when the mask 100 is worn by the user. FIG. 4a shows this in a preferred embodiment, and for the sake of comparison, FIG. 4b shows the fixing tapes of a prior art mask. The fixing around the head provides for a pleasant feeling even during prolonged use as compared to the prior art mask, in which the fixing means leads to a painful feeling around the ears when the mask 100 is worn for a longer period of time. Advantageously, even for glasses/spectacle wearers there is enough space between the mask and the face/glasses when the mask is about to be mounted into the final position on the head by the user. This is beneficial so that the glasses do not slip out of place.

The fixing tape 170 overlaps with the face part 105 in the longitudinal direction of the fixing tape 170 by a length L4 of 1 cm. The overlapping length is fixed to the face part 105 with two seams. One seam runs in the longitudinal direction of the overlapping length of the fixing tape 170 and is positioned at a vertically lower end of the fixing tape 170. The other seam runs in the direction perpendicular to that and is positioned close to the ending of the face part 105. The latter seam is a bartack stitch seam with a backtack stitch to prevent unravelling of the seam. This supports a firm fit and ensures mechanical integrity, well suited for prolonged use. In comparison to the prior art mask, the overlapping length is increased to improve the structural and mechanical integrity.

### 10. Enclosed Fixing Tape

Furthermore, FIG. 5 shows an embodiment of two longish and preferably elastic fixing tapes 170 of the face mask 100, wherein the overlapping lengths L4 of the fixing tapes 170 are enclosed by two longish and elastic binding tapes 180. The two binding tapes 180 are folded in half and enclose the upper and the lower edge of a plane panel 115 (also shown in the embodiment of FIG. 2c) of the face part 105. This enclosure also ensures that the overlapping lengths L4 of the fixing tapes 170 are enclosed and not exposed to the outside. Thus, they are protected from external impacts, which is beneficial for prolonged use. Furthermore, the binding tapes 180 are connected to the plane panel 115 by a seam. Part of this seam is the same as the one that attaches the fixing tape 170 in the longitudinal direction to the face part 105. With this arrangement, the number of seams is reduced and the manufacturing of the mask 100 is facilitated while the mechanical integrity is secured.

### 11. Further Aspects

FIG. 5 shows an exemplary embodiment of the face mask 100 with a nose clip 107 positioned at a mirror plane of the face of the head. The nose clip 107 extends to both sides of the mask and is enclosed by the binding tape 180. Thereby, the nose clip 107 is located close to the top edge 140 of the mask. The binding tape 180 is folded in half and connected to the face part 105 with a longitudinal seam, located substantially in parallel to the top edge 140 in a distance of about 0.5-0.7 mm. The nose clip 107 is fixed to the binding tape 180 so that relative movement with respect to the binding tape 180 is prevented. Thus, it is ensured that it is located at its preferred symmetrical position where it supports the shape of the mask 100 and the top edge 140 the most. It comprises material that supports maintaining a predefined shape. The user can manually adjust the nose clip 107 according to his own needs, e.g. so that it best fits to his individual nose.

Table 4 below lists the differences of the angles of a preferred embodiment according to FIG. 3d1 and the prior art mask according to FIG. 3d2.

TABLE 4
Comparison of angles of embodiments of the
present invention and the prior art mask

| Angle | Present application | Prior art |
|---|---|---|
| A1201 | 20° | 34° |
| A1202 | 22° | 30° |
| A1203 | 30° | |
| A1204 | 65° | |
| A1401 | 40° | 20° |
| A1402 | 70° | |
| A1403 | 147° | |
| A1501 | 110° | 138° |
| A150m | 136° | |
| A1601 | 109° | 125° |
| A1602 | 94° | 95° |

### Test Reports of Examples of Preferred Embodiments

It will also be appreciated that the masks may be configured to be compliant with a range of international respirator standards, as described in the following. A series of different face masks were tested according to the test protocols stated herein, for instance according to the standards of the National Institute for Occupational Safety and Health (NIOSH). Stringent requirements are prevailing for face masks as the one of the present invention. These requirements are manifested, e.g., in the Code of Federal Regulations (CFR) in title 42 “Public Heath”-under part 84 “Approval of respiratory protective devices”. The following tests comprise the 42 CFR 84.180 (Airflow resistance tests: Inhalation and Exhalation) and the CFR 84.181 (Non-powered air-purifying particulate filter efficiency level determination). A further test for the particulate filter efficiency is provided that is conducted on a TSI 8130 A Machine.

1. Inhalation Resistance Test: TEB-APR-STP-007 (42 CFR 84.180)

The resistance to airflow is measured in the facepiece of the particulate respiratory mask mounted on a test fixture with air flowing at continuous rate of 85±2 liters per minute, before each test conducted in accordance with 42 CFR 84.182. The resistances for particulate respirators upon initial inhalation shall not exceed 35 mm water column height pressure and upon initial exhalation shall not exceed 25 mm water column height pressure. The test results in the Table below confirm that the exemplary masks at least fulfill the N95 standard.

TABLE 5
Test results for inhalation TEB-APR-STP-007 (42 CFR 84.180)

| | Max. allowable | Actual inhalation | |
|---|---|---|---|
| | resistance (mm of | resistance (mm | |
| Specimen | H2O) (NIOSH N95) | of H2O) | Result |
| 1 | 35 | 9.0° | Pass |
| 2 | 35 | 8.5 | Pass |
| 3 | 35 | 9.7 | Pass |

For FFP2 standard (EN-149-2001) the max. allowable resistance value for inhalation is 24.5 mmH2O (240 Pa) at a flow rate of 95 liters per minute and 7.1 mmH2O (70 Pa) at a flow rate of 30 liters per minute. The tests indicate that all tested masks also fulfill the FFP2 requirement (manifested under the EU Norm EN 149) since there remains sufficient margin to cope with an increasing flow rate from 85 to 95 liters per minute.

2. Exhalation Resistance Test: TEB-APR-STP-003 (42 CFR 84.180)

Same procedure as for the inhalation resistance test applies for the exhalation resistance test in here. The test results in the Table below confirm that the exemplary masks at least fulfill the N95 standard.

TABLE 6
Test results for exhalation TEB-APR-STP-003 (42 CFR 84.180)

| | Max. allowable | Actual inhalation | |
|---|---|---|---|
| | resistance (mm of | resistance (mm | |
| Specimen | H2O) (NIOSH N95) | of H2O) | Result |
| 1 | 25 | 5.8° | Pass |
| 2 | 25 | 5.3 | Pass |
| 3 | 25 | 6.1 | Pass |

For FFP2 standard (EN-149-2001) the max. allowable resistance value for exhalation is 30.6 mmH2O (300 Pa) at a flow rate of 160 liters per minute. The tests indicate that all tested masks also fulfill the FFP2 requirement (manifested under the EU Norm EN 149) since there remains sufficient margin to cope with an increasing flow rate from 85 to 95 liters per minute.

3. Particulate Filter Efficiency Test: TEB-APR-STP-059 (42 CFR 84.181)

This test is suited for the determination of Particulate Filter Efficiency Level for N95 Series Filters Against Solid Particulates for Non-Powered, Air-Purifying Respirators. This procedure establishes the means for ensuring that the particulate filtering efficiency of N95 series filters used on non-powered respirators submitted for Approval, Extension of Approval, or examined during Certified Product Audits, meets the minimum certification standards set forth in 42 CFR, Part 84, Subpart K, § 84.181. These filters or filter cartridges may be integral to respirator construction; mounted individually, or in sets of up to three; used in conjunction with cartridges and canisters for chin-style, front-mounted, and back-mounted gas masks; or used in combination with gas-and-vapor or atmosphere-supplying respirators.

The content of the test procedure manifested within TEB-APR-STP-059 and 42 CFR 84.181 shall be considered to be comprised within this specification. The test results in the Table below confirm that the exemplary masks at least fulfill the N95 standard.

TABLE 7
Test results for particulate filter efficiency
test TEB-APR-STP-059 (42 CFR 84.181)

| | | | Max | | | | |
|---|---|---|---|---|---|---|---|
| | Flow | Initial Filter | Allowable | Initial | Max | Filtration | |
| | Rate | Resistance | Leakage | Leakage | Leakage | Efficiency | |
| Specimen | (Lpm) | (mmH₂O) | (%) | (%) | (%) | (%) | Result |
| 1 | 85.3 | 10.6 | 5.00 | 1.78 | 4.50 | 95.50 | Pass |
| 2 | 85.8 | 10.9 | 5.00 | 1.32 | 3.26 | 96.74 | Pass |
| 3 | 85.3 | 11.9 | 5.00 | 1.73 | 3.39 | 96.61 | Pass |
| 4 | 85.8 | 11.5 | 5.00 | 1.18 | 4.34 | 95.66 | Pass |
| 5 | 85.7 | 12.7 | 5.00 | 1.74 | 3.54 | 96.46 | Pass |
| 6 | 85.7 | 12.9 | 5.00 | 1.57 | 2.87 | 97.13 | Pass |
| 7 | 85.8 | 11.1 | 5.00 | 1.84 | 4.28 | 95.72 | Pass |
| 8 | 85.9 | 14.2 | 5.00 | 2.84 | 4.93 | 95.07 | Pass |
| 9 | 85.3 | 62.9 | 5.00 | 3.9 | 3.9 | 96.09 | Pass |
| 10 | 85.8 | 21.9 | 5.00 | 1.97 | 4.11 | 95.89 | Pass |
| 11 | 85.8 | 12.2 | 5.00 | 1.36 | 3.11 | 96.89 | Pass |
| 12 | 85.8 | 12.7 | 5.00 | 1.62 | 3.35 | 96.65 | Pass |
| 13 | 85.7 | 67.6 | 5.00 | 1.69 | 2.80 | 97.20 | Pass |
| 14 | 85.1 | 64.7 | 5.00 | 4.91 | 4.91 | 95.09 | Pass |
| 15 | 85.8 | 12.1 | 5.00 | 2.01 | 4.48 | 95.52 | Pass |
| 16 | 85.4 | 61.5 | 5.00 | 1.56 | 2.84 | 97.16 | Pass |
| 17 | 85.4 | 61.6 | 5.00 | 1.01 | 2.15 | 97.85 | Pass |
| 18 | 85.5 | 64.0 | 5.00 | 1.37 | 2.74 | 97.26 | Pass |
| 19 | 85.9 | 11.2 | 5.00 | 1.42 | 3.49 | 96.51 | Pass |
| 20 | 85.5 | 60.0 | 5.00 | 1.14 | 2.53 | 97.47 | Pass |

4. Particulate Filter Efficiency Test on a TSI 8130 A Machine

A further test regarding the particulate filter material (non-woven fabric) was conducted. The 8130 A machine is suited for test standards for instance according to US-standards 42 CFR 84, Chinese standards GB2626, Japanese standard JMOL and European standard EN 143, ISO 16900-3. The flow rate was 85 Lpm and the measured initial filter efficiency was in the range of 97.5%-99.5%, the loading test minimum efficiency was 95.5%-97.5% and the initial air resistance was 85 Pa. The test results confirmed that the exemplary particulate filter material at least fulfills the N95 and KN95 standard.

### LIST OF REFERENCE NUMBERS

100: Face mask
105: Face part
106: Sealing element
107: Nose clip
110a: Symmetrical region
110b: Symmetrical region
111: First layer of face mask
112: Second layer of symmetrical region
113: Third layer of symmetrical region
115: Plane panel
120: Front edge
121: At least one section, first section of first trajectory
122: At least another section, second section of first trajectory
123: Third section of first trajectory
124: Fourth section of first trajectory
125: Seam at front edge
128: Mouth section
140: Top edge
141: First section of T2
142: Second section of T2
150: Bottom edge
160: Rear edge
170: Fixing tape
180: Binding tape

1. A wash-durable and reusable respiratory face mask (100) for filtering air comprising a face part (105) configured to cover at least the nose and the mouth of a head of a user and comprising two substantially symmetrical regions (110a, 110b) and each region (110a, 110b) comprising a top edge (140) configured to form a trajectory (T2) which runs, when the mask (100) is worn by the user, from the bridge of the nose of the head towards an ear of the head,
wherein the trajectory (T2) comprises at least two sections (141, 142),
the first section (141) being configured to cover at least part of the nose when the mask (100) is worn by the user and forming a substantially convex bend,
and the second section (142) extending from the first section (141) towards an ear.

2. The mask (100) of claim 1, wherein the second section (142) forms a substantially concave bend.

3. The mask (100) of claim 1, wherein the acute angle (A1401) between the tangent (K1401) of the first section (141) at the start of the first section (141) and the tangent (K1403) of the second section (142) at the end of the second section (142) is in the range of 20-60°, preferably 30-50°, more preferably 35-45° and most preferably 37-43°.

4. The mask (100) of claim 1, wherein the maximum value of the acute angle (A1402) between the tangent (K1403) of the second section (142) at the end of the second section (142) and the tangent (K140m) of the first section (141) at any point of the first section (141) is in the range of 50-90°, preferably 60-80°, more preferably 65-75° and most preferably 68-72°.

5. The mask (100) of claim 1, wherein the obtuse angle (A1403) between the tangent (K1402) of the second section (142) at the start of the second section (142) and the tangent (K1403) of the second section (142) at the end of the second section (142) is in the range of 110-180°, preferably 130-165°, more preferably 139-155° and most preferably 143-151°.

6. The mask (100) of claim 1, wherein the point (P140m) in which the second section (142) extends from the first section (141) is located on the trajectory (T2) with the greatest perpendicular distance between the point (P140m) and a straight line connecting the start and the end of the trajectory (T2).

7. The mask (100) of claim 1, wherein
L1402 is in the range of 0.5-3.5 cm, preferably 1.0-3.0 cm, more preferably 1.5-2.5 cm, even more preferably 1.8-2.2 cm and most preferably 1.9-2.1 cm; and/or
L1402 is in the range of 5-40%, preferably 10-35%, more preferably 14-30%, even more preferably 18-26% and most preferably 20-24% of L1401;
wherein L1401 is the length of a straight line between the start and the end of the top edge (140) when the mask lies flat and is folded at its mirror plane, and L1402 is the greatest value of a perpendicular distance between a point (P140m) on the trajectory (T2) of the top edge (140) and L1401.

8. The mask (100) of claim 1, wherein the end of the trajectory T2 and/or the end of the top edge (140) is located in a negative-Y-direction of a length L1403 of 0.2-3.0 cm, preferably 0.4-2.0 cm, more preferably 0.5-1.5 cm and most preferably 0.7-1.2 cm, with respect to the point in which the second section (142) extends from the first section (141),
wherein the negative-Y-direction is the direction from the start of a front edge (120) to the end of a front edge (120) of the face part (105) wherein the front edge (120) is comprised by the face part (105) and located at the border between the two regions (110a, 110b) and configured to form a trajectory T1 which runs, when the mask (100) is worn by the user, from the bridge of the nose of the head to the chin of the head, substantially at the symmetrical mirror plane (M1) of the face.

9. The mask (100) of claim 1, wherein the mask (100) comprises a front edge (120) located at the border between the two regions (110a, 110b) and configured to form a trajectory (T1) which runs, when the mask (100) is worn by the user, from the bridge of the nose of the head to the chin of the head, substantially at the symmetrical mirror plane (M1) of the face,
wherein the front edge (120) comprises a seam (125) configured continuously along said trajectory (T1).

10. The mask (100) of claim 1, wherein the distance of any point on the trajectory (T1) from the symmetrical mirror plane (M1) of the face when the mask is worn by the user is at most 2.5 cm, preferably at most 2.0 cm, more preferably at most 1.5 cm and most preferably at most 1.0 cm.

11. The mask (100) of claim 9, wherein the seam (125) is a single stitch seam (125).

12. The mask (100) of claim 9, wherein,
the trajectory (T1) comprises at least two sections (121, 122), each of which forms a substantially straight line, the first section (121) being configured to cover at least part of the nose when the mask (100) is worn by the user and the second section (122) extending from the first section (121) towards the mouth, and
the acute angle (A1201) between the substantially straight lines formed by the first (121) and second sections (122) is in the range of 10-30°, preferably 15-25°, more preferably 17-23° and most preferably 18-22°.

13. The mask (100) of claim 12, wherein the trajectory (T1) comprises a third section (123) forming a substantially straight line and extending from the second section (122) towards the chin, and
the acute angle (A1202) between the substantially straight lines formed by the second (122) and third sections (123) is in the range of 12-32°, preferably 15-29°, more preferably 18-26° and most preferably 20-24°.

14. The mask (100) of claim 13, wherein the length of the third section (123) is in the range of 0.5-3.5 cm, preferably 1.0-3.0 cm, more preferably 1.5-2.5 cm and most preferably 1.8-2.2 cm.

15. The mask (100) of claim 14, wherein the trajectory (T1) comprises a fourth section (124) extending from the third section (123) to the chin and
the acute angle (A1203) between the substantially straight line of the third section (123) and the tangent (K1201) of the fourth section at the start of the fourth section (124) is in the range of 10-50°, preferably 20-40°, more preferably 25-35° and most preferably 27-33°.

16. The mask (100) of claim 15, wherein the acute angle (A1204) between the substantially straight line of the third section (123) and the tangent (K1202) of the fourth section at the end of the fourth section (124) is in the range of 35-90°, preferably 45-85°, more preferably 55-75° and most preferably 62-68°.

17. The mask (100) of claim 15, wherein the fourth section (124) forms a continuous bend such that
L6b is in the range of 2.0-12.0%, preferably 4.0-10.0%, more preferably 5.5-8.5%, even more preferably 6.0-8.0% and most preferably 6.5-7.5% of L5b;
wherein L5b is the length of a straight line between the start and the end of the fourth section (124) when the mask (100) lies flat and is folded at its mirror plane, and L6b is the greatest value of a perpendicular distance between a point on the fourth section (124) and L5b.

18. The mask (100) of claim 1, wherein
one or more hydrophilic agents and/or one or more antimicrobial agents are adhered to the mask; and/or wherein
the mask (100) is at least N90/R90/P90-rated, preferably at least N95/R95/P95-rated and most preferably at least N99/R99/P99-rated.

19. The mask (100) of claim 1, wherein
the face part (105) comprises at least one, preferably two, three or more layers (111, 112, 113); and/or wherein
at least one layer (111, 112) comprises a textile material and wherein at least one layer (113) comprises a particulate filter material.

20. The mask (100) of claim 1, wherein
a layer (111, 112) comprising textile of woven fabrics is an outer layer (111) exposed to the outside when the mask (100) is worn by a user; and/or wherein
a layer (111, 112) comprising textile from the group consisting of knitted, warp-knitted, and crocheted fabrics preferably knitted fabrics is an inner layer (112) exposed to the face when the mask (100) is worn by a user.
